(19) United States
(12) Patent Application Publication
(10) Pub. No.: US 2014/0129221 A1
(43) Pub. Date: May 8, 2014

(54) SOUND RECOGNITION DEVICE, NON-TRANSITORY COMPUTER READABLE STORAGE MEDIUM STORED THREREOF SOUND RECOGNITION PROGRAM, AND SOUND RECOGNITION METHOD

(71) Applicant: Dwango Co., Ltd., (US)

(72) Inventor: Wataru KASAI, Tokyo (JP)

(21) Appl. No.: 13/848,895

(22) Filed: Mar. 22, 2013

Related U.S. Application Data
(60) Provisional application No. 61/614,811, filed on Mar. 23, 2012.

(51) Int. Cl. G10L 15/05

(52) U.S. Cl. CPC G10L 15/05
USPC 704/240; 704/251

(57) ABSTRACT

A sound recognition device includes a storage for storing a comment that is input while the user listening to sounds emitted as multimedia data being played. The sound recognition device further includes an extractor for extracting a word that appears in a set of sentences that contains the stored comment, and candidate words that contain co-occurrences of the word in the set of sentences. Furthermore, the sound recognition device includes a sound recognizer for recognizing sounds emitted as the multimedia data being played, based on the extracted candidate words.

### CROSS-REFERENCE TO RELATED APPLICATION

This application claims the benefit of the Provisional Application 61/614,811, filed on Mar. 23, 2012, the entire disclosure of which is incorporated by reference herein.

### FIELD

The present invention relates to a sound recognition device for recognizing sounds included in multimedia data, non-transitory computer readable storage medium stored thereof a sound recognition program, and a sound recognition method.

### BACKGROUND

Conventionally, various types of multimedia data have been widely provided by live broadcast distribution of videos and audios, and by on-demand distributions and the like of pre-recorded video and audio streaming and the like.

Here, a comment distribution system that incorporates displaying a comment to another user who is listening to multimedia data when a user who also listens to this multimedia data makes an input of the comment in response to the multimedia data while listening thereof, has been introduced (see Japanese Patent No. 4263218).

On the other hand, a technique which involves performing a sound recognition per word unit using candidate words that are prepared in advance and a probability of occurrence of these candidate words, has been introduced (see Akinobu Lee and Tatsuya Kawahara, Recent Development of Open-Source Sound Recognition Engine Julius, Proceedings: APSIPA ASC 2009: Asia-Pacific Signal and Information Processing Association, 2009 Annual Summit and Conference, pp. 131-137, Oct. 4, 2009. http://hdl.handle.net/2115/39653). In addition, a technique of improving an accuracy of sound recognition by analyzing chronological correspondence between a voice and a text transcribed from the voice by a dictation, has been introduced (see Japanese Patent No. 4758919).

In the present state of multimedia data distribution where substantial numbers of multimedia data are provided, there is increasing need to attach subtitles to videos that are included in the multimedia data, and also, there is increasing need for summarized texts of multimedia data, in addition to text retrievals of multimedia data. Accordingly, there is a strong need for a much more optimized voice conversion to text for the voices included in the multimedia data.

On the other hand, due to a changeable nature of words that occur in voices depending on topics of conversation, the fashions and styles of each time period, speakers, and preferences of audience, a dictation technique capable of adapting to such changes is certainly desired.

The present invention has been made to solve the above problems, and the object of the invention is to provide a sound recognition device for a suitable recognition of sounds included in multimedia data, a non-transitory computer readable storage medium stored thereof a sound recognition program, and a sound recognition method.

### SUMMARY

To achieve the aforementioned objective, a first aspect of a sound recognition device according to the present invention includes,

a storage for storing a comment that is input by a user while listening to a sound emitted via playing multimedia data,

an extractor for extracting candidate words including a word occurred in a set of sentences that contain the stored comment, and a co-occurrence of the word contained in the set of sentences, and

a sound recognizer for recognizing the sound emitted via playing the multimedia data, recognizing based on the extracted candidate words.

The sound recognition device of the first aspect may include,

the set of sentences comprising a sentence that occurred in a document viewed by the user of the multimedia data.

Further, the sound recognition device of the first aspect may include,

the extractor determines a likelihood of occurrence for the each candidate word, and

the sound recognizer recognizes the sound based on a degree of coincidence between a phoneme that is recognized in the sound and a phoneme that describes the candidate words, and on the likelihood of occurrence of the candidate words.

Yet further, the sound recognition device of the first aspect may include,

a word among the candidate words, that occurred in the comment, is associated with an input time point at which an input of the comment is made,

as for the candidate words associated with the input time point, the sound recognizer requests to obtain a degree of coincidence between an input time point associated with the candidate words, and a sound emission time point at which the phoneme is emitted, and the sound recognizer further performs a sound recognition based on the obtained degree of coincidence.

Yet, further, the sound recognition device of the first aspect may include,

the input time point and the sound emission time point are depending on a period of play time starting from a multimedia data play start.

Yet further, the sound recognition device of the first aspect may include,

the degree of coincidence is defined based on a difference between the input time point and the sound emission time point, and a difference between a time point at which the multimedia data is ready to play and a time point at which the user started to play the multimedia data.

A non-transitory computer readable storage medium stored thereof a sound recognition program of a second aspect according to the present invention executable by a computer, causing the computer to realize functions of,

storing a comment that is input by a user while listening to a sound emitted via playing multimedia data,

extracting candidate words including a word occurred in a set of sentences that contain the stored comment, and a co-occurrence of the word contained in the set of sentences, and

recognizing the sound emitted via playing the multimedia data, and recognizing based on the extracted candidate words.

A sound recognition method of a third aspect according to the present invention includes the steps of,

storing a comment that is input by a user while listening to a sound emitted via playing multimedia data,

extracting candidate words including a word occurred in a set of sentences that contain the stored comment, and a co-occurrence of the word contained in the set of sentences, and

recognizing the sound emitted via playing the multimedia data, and recognizing based on the extracted candidate words.

The sound recognition device, the non-transitory computer readable storage medium stored thereof the sound recognition program, and the sound recognition method according to the present invention are capable of performing suitable recognition of sounds included in the multimedia data by using a comment attached to the multimedia data.

### BRIEF DESCRIPTION OF THE DRAWINGS

A more complete understanding of this application can be obtained when the following detailed description is considered in conjunction with the following drawings, which are as follows:

FIG. 1 is a system diagram showing an example of a configuration of a sound recognition system;

FIG. 2 is a hardware diagram showing an example of the sound recognition device of embodiments according to the present invention;

FIG. 3A is one part of a flowchart showing an example of a live broadcasting process that is preformed by the sound recognition device;

FIG. 3B is the rest of the flowchart showing an example of a live broadcasting process that is preformed by the sound recognition device;

FIG. 4 is a function block diagram showing an example of functions contained in the sound recognition device of Embodiment 1;

FIG. 5 is a view showing an example of a broadcasting table stored by the sound recognition device;

FIG. 6 is a view showing an example of a comment table stored by the sound recognition device;

FIG. 7 is a view showing an example of a viewer screen displayed by a terminal device of Embodiment 1;

FIG. 8A is one part of a flowchart showing an example of a re-broadcasting process performed by the sound recognition device;

FIG. 8B is the rest of the flowchart showing an example of a re-broadcasting process performed by the sound recognition device;

FIG. 9 is a flowchart showing an example of a summary creating process performed by the sound recognition device of Embodiment 1;

FIG. 10 is a view showing an example of a reference table stored by the sound recognition device;

FIG. 11 is a view showing an example of a sentence set table stored by the sound recognition device;

FIG. 12 is a view showing an example of a co-occurrence table stored by the sound recognition device;

FIG. 13 is a view showing an example of a candidate word table stored by the sound recognition device;

FIG. 14 is a view showing an example of a degree of coincidence curve given by data stored on the sound recognition device;

FIG. 15 is a flowchart showing an example of a sentence-set creating process performed by the sound recognition device;

FIG. 16 is a flowchart showing an example of a candidate-word extraction process performed by the sound recognition device;

FIG. 17A is one part of a flowchart showing an example of a continuous sound recognition process performed by the sound recognition device;

FIG. 17B is the rest of the flowchart showing an example of a continuous sound recognition process performed by the sound recognition device;

FIG. 18 is a flowchart showing an example of a summary creating process performed by the sound recognition device of Embodiment 2;

FIG. 19 is a function block diagram showing an example of functions contained in the sound recognition device of Embodiment 2;

FIG. 20 is a view showing an example of a co-occurrence table stored by the sound recognition device of Embodiment 2; and

FIG. 21 is a view showing an example of a viewer screen displayed by a terminal device of Embodiment 3.

### DETAILED DESCRIPTION

Hereinafter, the embodiments of the present invention is explained with reference to figures attached herein.

### Embodiment 1

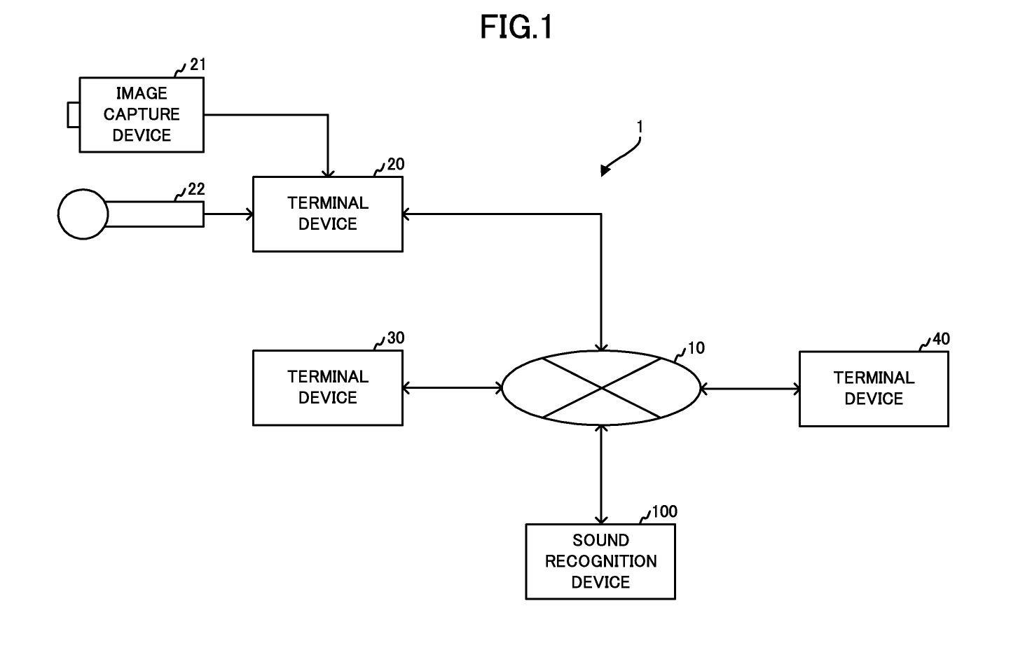

A sound recognition device 100 of Embodiment 1 according to the present invention is constituted by a sound recognition system 1 as shown in FIG. 1.

Besides the sound recognition device 100, the sound recognition system 1 is constituted by, for example, a computer communication network 10 such as interne (hereinafter simply referred to as, the communication network 10), and terminal devices 20, 30 and 40 that are connected to the communication network 10.

Each of the terminal devices 20 to 40 are constituted by a personal computer respectively including, for example, a display such as an LCD (liquid crystal display), an audio output such as a speaker, and an input such as a keyboard and a mouse.

Further, the terminal device 20 is connected to, for example, an image capture device 21 such as a web camera, and a sound collector 22 such as a microphone.

The sound recognition device 100 receives multimedia data which describes a video that is captured by the image capture device 21 and a sound that is collected by the sound collector 22, from the terminal device 20, then sends the received multimedia data from the terminal 20 to the terminal 40. In this way, the video captured by the image capture device 21 and the sound collected by the sound collector 22 can be broadcasted as the video and sound of a broadcasting program.

In the following discussion, it is assumed that the sound recognition device 100 broadcasts a program on which the user of the terminal 20 makes an appearance, and the program is broadcasted to the terminals 20 and 30 within a predetermined period of time from the beginning of the broadcast program filming (hereinafter referred to as, the live broadcast). Note that the user of the terminal device 20 appears on the program while he/she is viewing the broadcasted program.

Further, in the following discussion, it is also assumed that the sound recognition device 100 broadcasts (hereinafter referred to as re-broadcasting) the live broadcasted program (hereinafter referred to as, the live broadcast program) to the terminal device 40 after a predetermined time period is past from the beginning of the program filming.

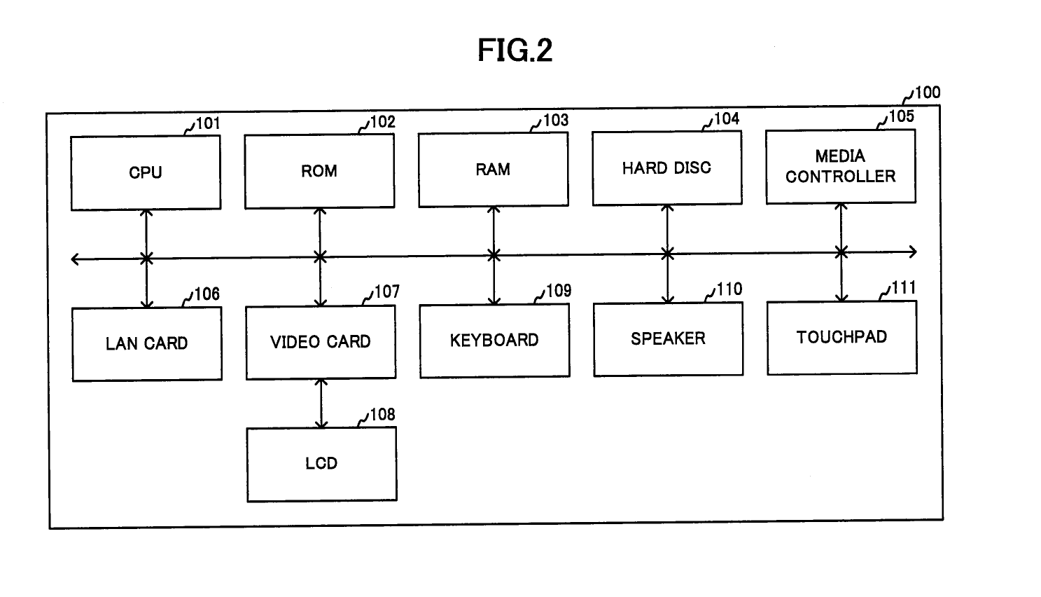

Now, the hardware diagram of the sound recognition device 100 is explained with reference to FIG. 2. The sound recognition device 100 is constituted by a server as shown in FIG. 2, and also constituted by a CPU (central processing unit) 101, a ROM (read only memory) 102, a RAM (random access memory) 103, a hardware disc 104, a media controller 105, a LAN (local area network) card 106, a video card 107, an LCD (liquid crystal display) 108, a keyboard 100i, a speaker 110, and a touchpad 111.

The CPU 101 conducts a comprehensive control of the sound recognition device 100 by running programs according to the programs stored on the ROM 102 or the hard disc 104. The RAM 103 is a work memory for temporarily storing a data that would be used for processing during the program execution by the CPU 101.

The hard disc 104 is a storage for storing tables in which various data are stored. Here, note that the sound recognition device 100 may include a flash memory as an alternative to the hard disc 104.

The media controller 105 reads out various data and programs from a storage medium such as the flash memory, a CD (compact disc), a DVD (digital versatile disc), and a Blu-ray Disc (registered trademark).

The LAN card 106 receives and transmits a data between the terminal devices 20 to 40 that are connected via the communication network 10. The keyboard 100i and the touchpad 111 input a signal according to the user's operation.

The video card 107 draws an image (in other words, performs rendering) based on a digital signal that is output from the CPU 101, and also outputs an image signal that represents the drawn image. The LCD 108 displays an image according to the output image signal from the video card 107. Note that the sound recognition device 100 may include a PDP (plasma display panel) or an EL (electroluminescence) display as alternatives for the LCD 108. The speaker 110 outputs a sound based on the signal that is output from the CPU 101.

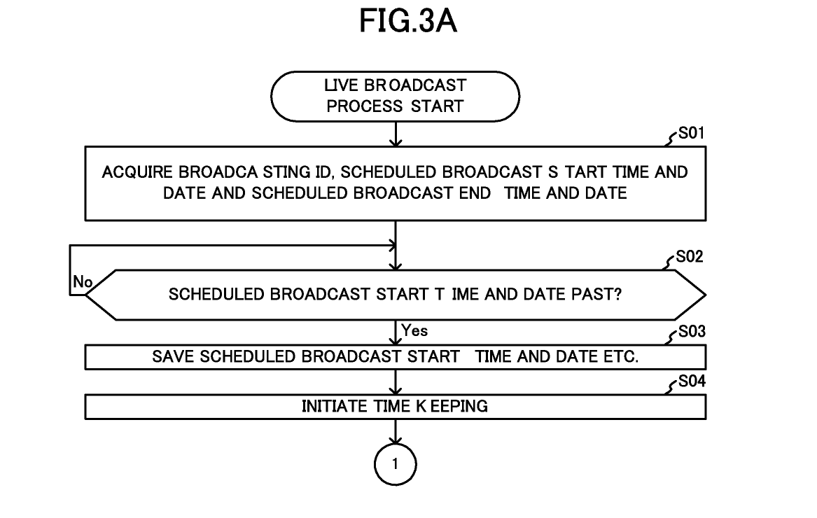

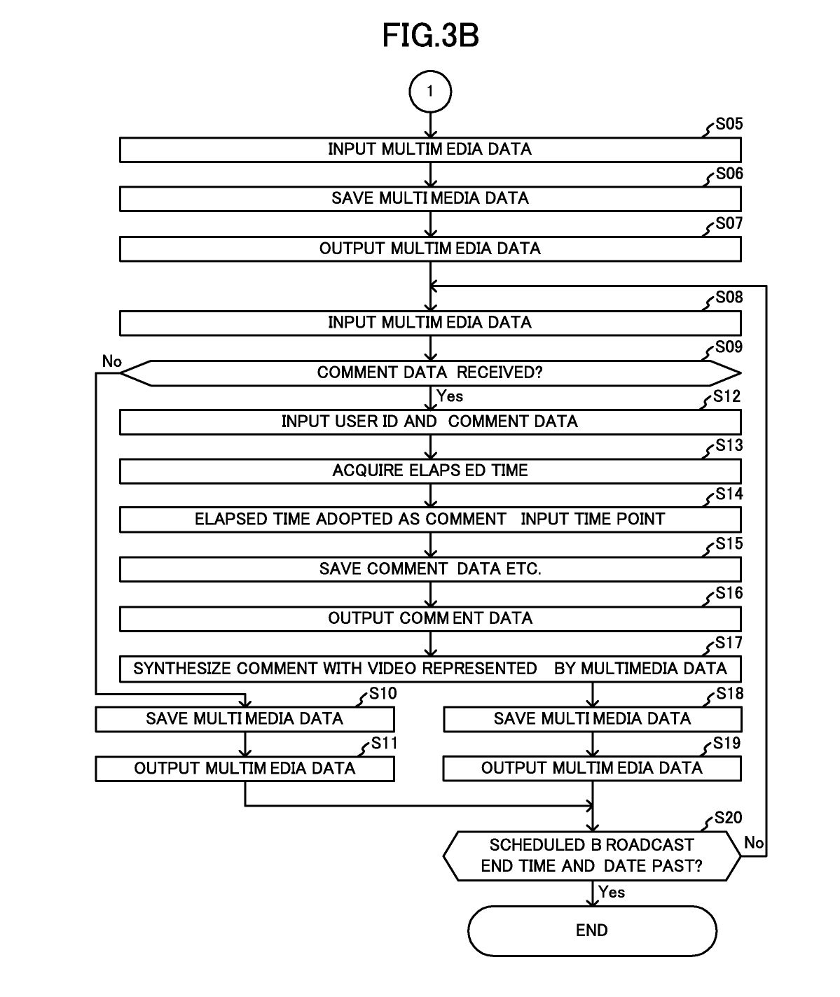

Now, the functions of the sound recognition device 100 are explained. Due to the CPU 101 executing the live broadcasting process shown in FIG. 3A and FIG. 3B, the CPU 101 is allowed to function as an input 120, a saver 130, and an output 140. Further, the CPU 101 functions as a storage 190 by working in synergy with the hard disc 104 shown in FIG. 2.

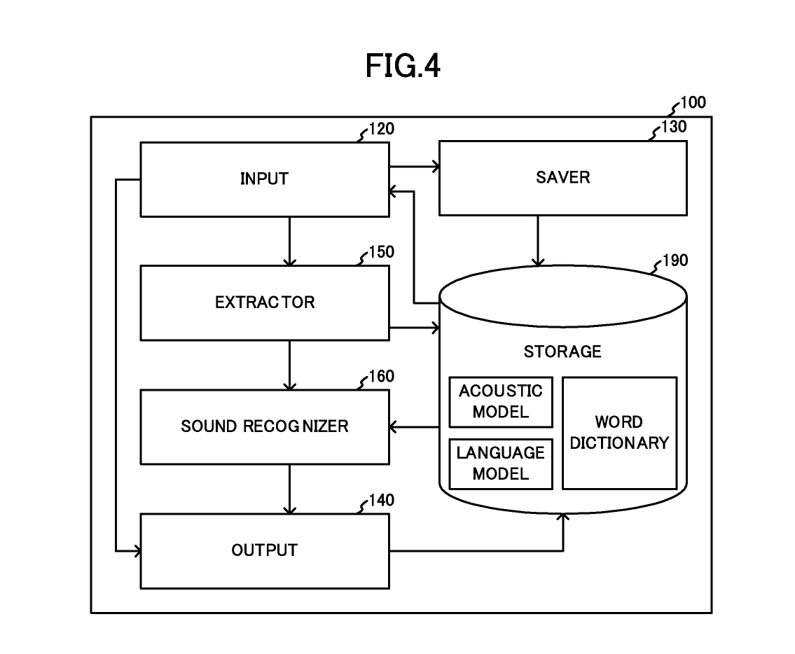

FIG. 4 shows the input 120 that inputs various data received on the LAN card 106 shown in FIG. 2. The saver 130 saves the various data that are input by the input 120 on the storage 190. The output 140 outputs the various data that are input by the input 120 to the LAN card 106 by specifying a destination of distribution. The storage 190 stores the various data saved by the saver 130.

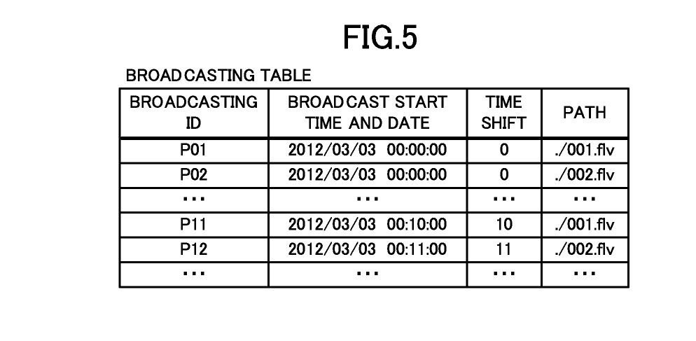

Now, various data that are stored in the storage 190 are explained. The storage 190 stores the broadcasting table shown in FIG. 5 on which a bibliography of the broadcasted program is saved. In the broadcasting table, multiple data are saved, wherein the multiple data are associations of a broadcasting ID that identifies the program broadcasting, a broadcast start time and date of the program, a time shift of the broadcasting, and a path for the multimedia data that describes the video and sound used in the broadcasted program. Note that the broadcast start time and date of the program means a time and date at which the program broadcast is established. As for the time shift of the broadcasting, a value “zero” is taken for the time shift if the broadcasting is a live broadcast, while if the broadcasting involves a re-broadcasting, then the value obtained by subtracting a live broadcast start time and date from the re-broadcast start time and date would be taken for the time shift.

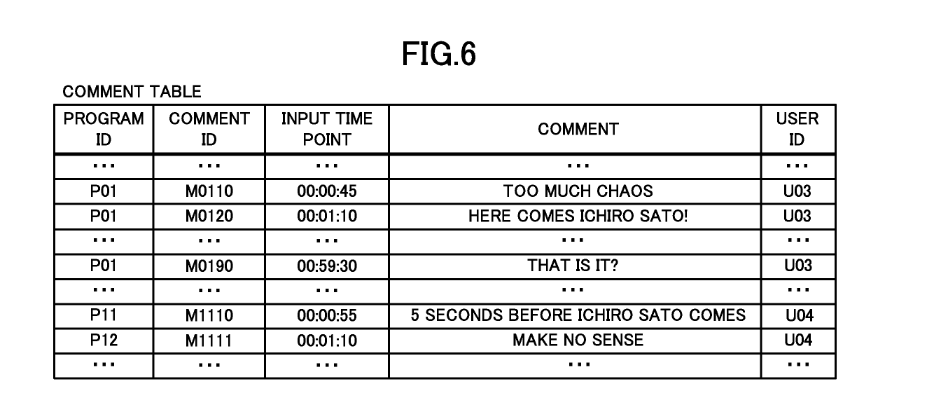

Further, the storage 190 stores a comment table shown in FIG. 6 on which comments for the video and sound of the program are saved. In the comment table, multiple data are saved, wherein the multiple data are associations of a broadcasting ID of a program, a comment ID that identifies a comment for the program, a point at which an input of the comment is made, the comment, and a user ID for identifying a user who made the comment. Note that the time at which the input is made is described by an elapsed time from the program broadcast start.

Here, operations of the CPU 101 that are performed by the input 120, the saver 130, and the output 140 shown in FIG. 4 are explained.

The user operation (hereinafter referred to as, the “instruction operation to start live broadcasting”) is made to send an instruction on the keyboard 109 of the sound recognition device 100 to start a live broadcasting. The user then operates on the keyboard 109 to send an instruction for a scheduled time and date to start the broadcasting (hereinafter referred to as, the “scheduled broadcast start time and date”), and a scheduled time and date for the completion of the broadcasting (hereinafter referred to as the “scheduled broadcast end time and date”).

The CPU 101 establishes an execution of the live broadcasting process shown in FIG. 3A and FIG. 3B as soon as an operation signal that indicates the instruction operation to start live broadcast is input on the keyboard 109.

When the live broadcast process is executed, the input 120 creates a broadcasting ID, and acquires the scheduled broadcast start time and date and the scheduled broadcast end time and date, which are specified by the user's operation, and these are acquired based on the operation signal that is input on the keyboard 109 (step S01).

Further, the saver 130 makes reference to, for example, a system time and date that is managed by an OS (operating system), and determines whether the referred system time and date is past the scheduled broadcast start time and date (step S02). In this, if the saver 130 determines the scheduled broadcast start time and date is not yet past (step S02: No), the processes in the step S02 are again executed after entering into a sleeping state for a predetermined period.

In the step S02, if the saver 130 determines that the scheduled broadcast start time and date is past (step S02: Yes), then the referred system time and date is assigned for a time and date to start broadcasting. Here, due to the nature of live broadcasting, the saver 130 applies a value “zero” for a time shift of the broadcasting. Further, the saver 130 creates a path for an electronic file on which a multimedia data that describes video and sound contained in the program are being saved, and the saver 130 creates an electronic file for the created path. The saver 130 then associates the broadcasting ID, the time and date for broadcasting, the time shift, and the path, and saves onto the broadcasting table shown in FIG. 5 (step S03).

Now, the saver 130 initiates a software timer to keep time from the program broadcast start to obtain an elapsed time (step S04).

Here, in the following discussion, it is assumed that the scheduled broadcast start time and date is already past by this time, and the user of the terminal device 20 initiates image capturing with the image capture device 21 connected to the terminal device 20, and operates the terminal device 20 to initiate sound set by the sound collector 22.

The terminal device 20 establishes image capturing with the image capture device 21 and sound collecting with the sound collector 22 according to the aforementioned operation. The terminal device 20 then begins to input, for example, a data (hereinafter, the “video data”) that represents a video of an image-captured figure of a performer, and that the input is made on the image capturing device 21. Further, the terminal device 20 begins to input an electric signal (hereinafter, the “audio signal”) that indicates a sound such as a sound given by the performer, and that the input is made on the sound input device 22. The terminal device 20 creates a sound data based on the audio signal that is input, and then begins transmitting multimedia data to the sound recognition device 100. Here, the multimedia data is constituted by association of the created sound data and the video data that are input on the image capture device 21, in which the data are associated with a time and date of data input and a created time and date.

Further, the input 120 inputs the multimedia data using the LAN card 106 shown in FIG. 2, wherein the multimedia data is received on the LAN card 106 in the terminal device 20 (step S05).

Yet further, the saver 130 further saves the multimedia data that is input on the electronic file found within the aforementioned path (step S06).

Then, the output 140 outputs the multimedia data that is input into the LAN card 106 shown in FIG. 2 with receiving addresses at the terminal devices 20 and 30 (step S07). After this, the LAN card 106 sends (in other words, live broadcasts) the multimedia data to the terminal devices 20 and 30.

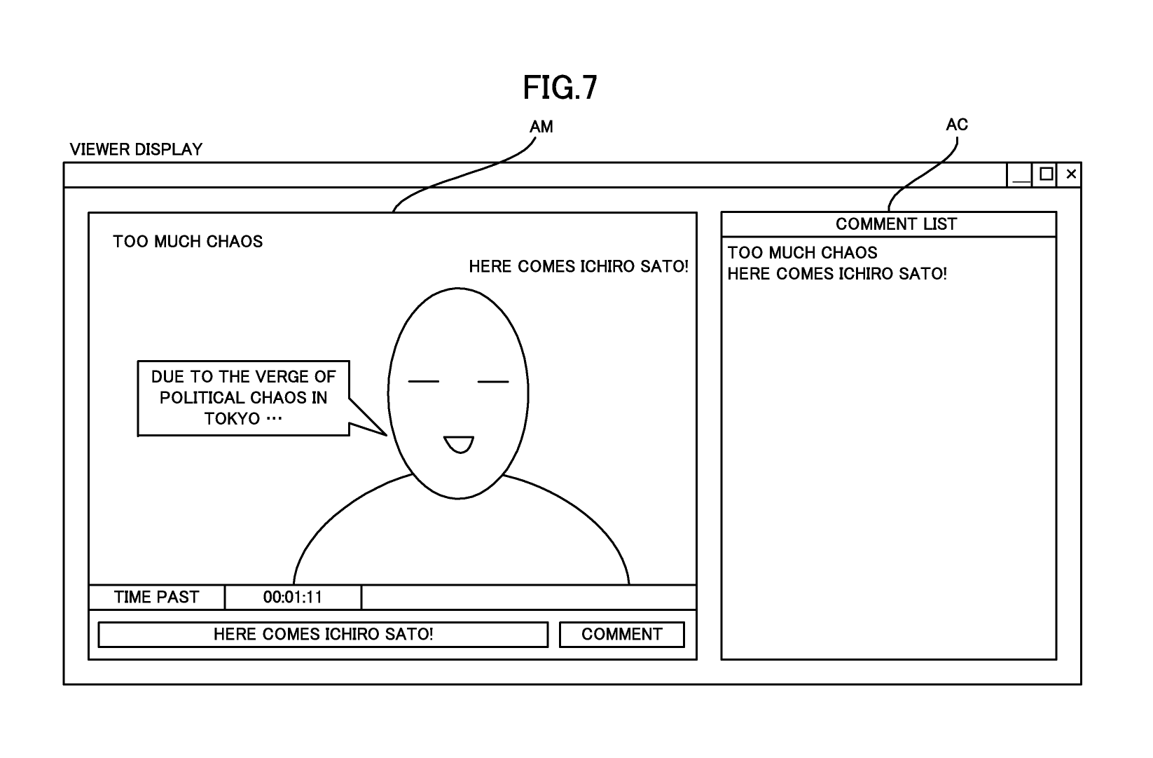

Here, as soon as the terminal devices 20 and 30 receive the multimedia data from the sound recognition device 100, the terminal devices 20 and 30 display the viewer screen shown in FIG. 7 which is used to display the video that is represented by the multimedia data. The terminal devices 20 and 30 then display the video that represents the played multimedia data on a video display area AM located within the viewer screen, and output the played sound from a sound output device.

Hereinafter, the user of the terminal device 20 is assumed to have given a dictation, “Due to the verge of political chaos in Tokyo”, and also, the dictation is given in front of the image capture device 21 and as facing straight thereagainst. Accordingly, a video that is captured from the front side as the user of the terminal device 20 dictates, is displayed on the viewer screen shown in FIG. 2, and the sound, “Due to the verge of political chaos in Tokyo”, is output from the terminal devices 20 and 30.

Further, the users of the terminal devices 20 and 30 who viewed the program certainly may or may not implement an input operation to the terminal device 30 to input a comment on the program that has been just viewed. In this, if the user implements this operation on the terminal device 30, the terminal device 30 then inputs the comment, and transmits comment data that indicates the input comment and the user ID of the user who made the comment, which are output to the sound recognition device 100.

After executing the step S07 shown in FIG. 3B, the input 120 inputs the multimedia data by executing the same process defined in the step S05 (step S08).

Further, the input 120 determines whether the comment data is received by the LAN card 106, based on a signal that is output from the LAN card 106 shown in FIG. 2 (step S09).

In this, if the input 120 determines that the LAN card 106 has not received the comment data (step S09: No), then the same processes defined in the step S06 and the step S07 are executed to save and to output the comment data (step S10 and step S11).

On the other hand, if the input 120 determines that the LAN card 106 has received the comment data (step S09: Yes), then the comment data received by the LAN card 106 and the user ID are input using the LAN card 106 (step S12).

After that, the saver 130 refers to the software timer to acquire an elapsed time from the live broadcast start time and date (step S13). The saver 130 then uses the acquired elapsed time as the time at which the comment is input (step S14). Thereafter, the saver 130 creates a comment ID of the comment that is represented by a comment data.

Further, the broadcasting ID of the program, the time point at which the comment is input in response to the broadcast program along with the comment ID, the comment, and the user ID of the user who has given the comment, are associated with each other and saved by the saver 130 in the comment table shown in FIG. 6 (step S15).

Thereafter, the output 140 outputs the comment data that is input on the LAN card 106 shown in FIG. 2 with having destination addresses at the terminal devices 20 and 30 (step S16). The LAN 106 then sends the comment data to the terminal devices 20 and 30.

When the terminal devices 20 and 30 receive the comment data through the sound recognition device 100, the terminal devices 20 and 30 then display the comment represented by the comment data in the comment display area AC on the viewer screen shown in FIG. 7.

Now, the saver 130 synthesizes the comment represented by the comment data that is input in the step S12 with the video represented by the multimedia data that is input at the step S08 (step S17).

After that, the saver 130 further saves the multimedia data that represents the comment-synthesized video onto the aforementioned file in the path (step S18).

Now, the output 140 outputs the comment-synthesized multimedia data to the LAN card 106 shown in FIG. 2 with destination addresses at the terminal devices 20 and 30 (step S19). The LAN card 106 then sends the multimedia data to the terminal devices 20 and 30.

When the terminal devices 20 and 30 receive the multimedia data through the sound recognition device 100, the terminal devices 20 and 30 play the multimedia data and display the comment synthesized video in the video display area AM on the viewer screen shown in FIG. 7.

Hereinafter, it is assumed that a viewer using the terminal device 30 has heard the dictation that is output, “Due to the verge of political chaos in Tokyo”, and he/she has input a comment, “Too much chaos”, in response to the dictation on the terminal device 30. Further, it is also assumed that this viewer has viewed an image of a performer displayed on the viewer screen, and has input a comment which making reference to the performer's name, “Here comes Ichiro Sato!”, which has been input on the terminal device 30. Accordingly, the comments, “Too much chaos” and “Here comes Ichiro Sato!”, are displayed on the comment display area AC of the viewer screen shown in FIG. 7. While on the video display area AM, the comments, “Too much chaos” and “Here comes Ichiro Sato!”, are synthesized with a video of a front figure of the performer, and displayed on the video display area AM.

After the step S11 or the step S19 are executed, the input 120 refers to a system time and date, and determines whether the referred system time and date is past the scheduled live broadcast end time and date acquired in the step S01 (step S20). In this, if the input 120 determines that the scheduled live broadcast end time and date is not past (step S20: No), then the processes are executed again from the step S08.

If the input 120 determines in the step S20 that the scheduled live broadcast end time and date is past (step S20: Yes), then the live broadcast process is terminated.

Now, operations of the CPU 101 are explained with reference to an example, which involves re-broadcasting of a program that is previously live broadcasted by the sound recognition device 100, and the user of the terminal device 40 viewing this program.

Here, the user of the terminal device 40 operates the terminal device 40 to transmit a request (hereinafter referred to as, the “re-broadcast request”) to the sound recognition device 100 after a predetermined period of time is past from the start of live broadcast, to request a re-broadcast of the live broadcasted program. The terminal device 40 transmits the re-broadcast request to the sound recognition device 100 according to this operation.

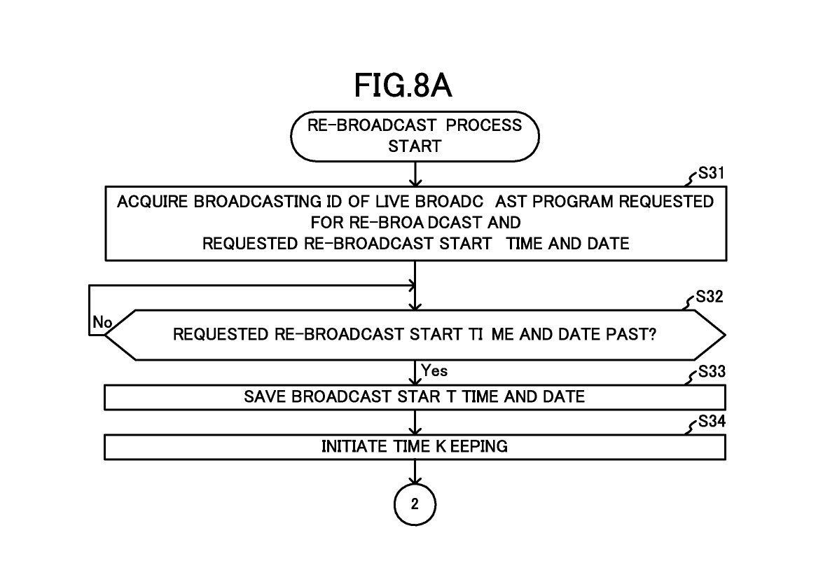

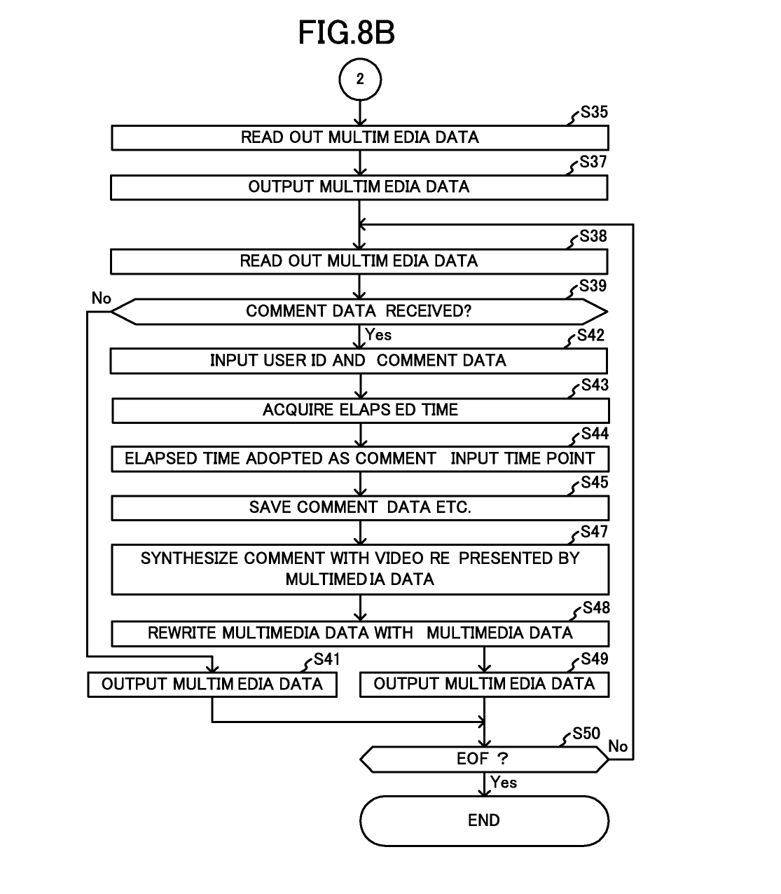

When the LAN card 106 shown in FIG. 2 receives the re-broadcast request, the CPU 101 then initiates an execution of the re-broadcast that is shown in FIG. 8A and FIG. 8B.

Firstly, the input 120 creates a broadcasting ID, and inputs the received re-broadcast request using the LAN card 106. The input 120 then acquires a broadcasting ID of the live broadcast program that has been requested for re-broadcasting, and a time and date to establish the re-broadcast (hereinafter referred to as, the “requested re-broadcast time and date”) (step S31).

Further, the saver 130 refers to a system time and date to determine whether the referred system time and date is past the requested live broadcast start time and date (step S32). In this, if the saver 130 determines the requested re-broadcast start time and date is not yet past (step S32: No), then the process in the step S32 is executed again subsequently after a predetermined period of standby.

In the step S32, if the saver 130 determines that the requested re-broadcast start time and date is past (step S32: Yes), then a system time and date is referred to use this referred system time and date as the broadcast start time and date for re-broadcasting. Afterwards, the saver 130 retrieves the broadcast start time and date and a path, which are associated with the broadcasting ID of the live broadcast program that is requested for the re-broadcast, that are retrieved from a broadcasting table shown in FIG. 5. After that, the saver 130 calculates a difference between the re-broadcast start time and date and the live broadcast start time and date such that the obtained difference is exploited for a time shift. Then, the broadcasting ID of the re-broadcast, the re-broadcast start time and date, the time shift of the re-broadcast, and the path of the live broadcast program that is re-broadcasted, are associated with each other, and saved by the saver 130 on the broadcasting table shown in FIG. 5 (step S33).

Further, the saver 130 initiates a time keeping for an elapsed time from the re-broadcast start time and date, by executing the same process given in the step S04 (step S34).

Further, the input 120 reads out predetermined sized multimedia data from the aforementioned electronic file in the path (step S35).

Then, the output 140 outputs the multimedia data, that has been read out, to the LAN card 106 shown in FIG. 2 with a destination address at the terminal device 40 (step S37). The LAN card 106 then transmits the multimedia data to the terminal device 40. The terminal device 40 displays the comment-synthesized video in which the comment is input by the user of the terminal device 30, and outputs the sound via playing multimedia data that has been received (so called, the time shift play).

Further, the user of the terminal device 40 views the re-broadcasted program and he/she certainly may or may not operate the terminal device 40 to input a comment on the program.

Now, the input 120 carries an execution of the same process given in the step S35 to read out the multimedia data (step S38).

The input 120 then determines whether the LAN card 106 is received comment data, by executing the same process given in the step S09 shown in FIG. 3B (step S39).

In this, if the input 120 determines that the LAN card 106 is not received comment data (step S39: No), then the same process given in the step S37 is executed to output the multimedia data that was read out in the step S38 (step S41).

In the step S39, if the input 120 determines that the LAN card 106 has received comment data (step S39: Yes), the same processes given in the step S12 through the step S17 shown in FIG. 3B are executed (step S42 to step S47). Accordingly, a synthesized multimedia data can be created, wherein the multimedia data is a synthesis of the video with the comment, and the video represented by the multimedia data is read out in the step S38, and the comment represented by the comment data is input in the step S42.

Further, the saver 130 rewrites the multimedia data that is read out in the step S38 out of the entire multimedia data that are saved on the aforementioned electronic file in the path, and is rewritten into the multimedia data that is created in the step S47 (step S48).

The output 140 then executes the same process given in the step S19 as shown in FIG. 3B (step S49). Hence, the multimedia data that represents the comment-synthesized video can be transmitted, and this comment is input by the user of the terminal device 40.

After the process in the step S41 or the process in the step S49 are executed, the input 120 shifts a position (hereinafter the “read-out position”) in backwards in order to read out the multimedia data from the aforementioned electronic file in the path, and the position is shifted backwards by a size of the multimedia data that is read out. The input 120 then determines whether the read-out position is found at the end of the electronic file, an EOF (end of file) (step S50). In this, if the input 120 determines that the read-out position is not found in the EOF (step S50: No), then the processes from the step S38 through the above are again executed.

In the step S50, if the input 120 determines that the read-out position is the EOF (step S50: Yes), then the re-broadcast routine is terminated.

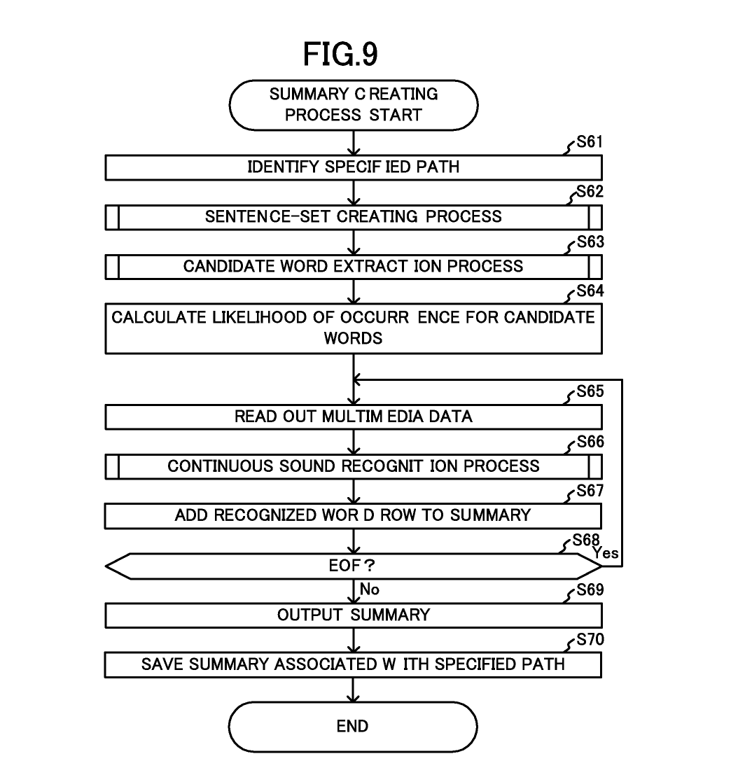

The CPU 101 in the sound recognition device 100 executes the summary creating process shown in FIG. 9 to create a summarized text of a dictation given during the program that is used for a retrieval key of the broadcasted program, or as a subtitle attached onto the video of the broadcasted program. Accordingly, the CPU 101 serves to function as an extractor 150 and a sound recognizer 160 in addition to serving as the aforementioned input 120, the saver 130, and the output 140. The CPU 101 also serves as the storage 190 by working in synergy with the hard disc 104, as discussed above.

The extractor 150 extracts candidate words (hereinafter referred to as the “candidate words”) of a word. The word describes a sound that is spoken aloud on the program, and the candidate words are extracted from the comments or the like stored on the storage 190. The sound recognizer 160 recognizes the sound that is emitted via playing the multimedia data, and the sound recognizer 160 recognizes the sound based on the extracted candidate words.

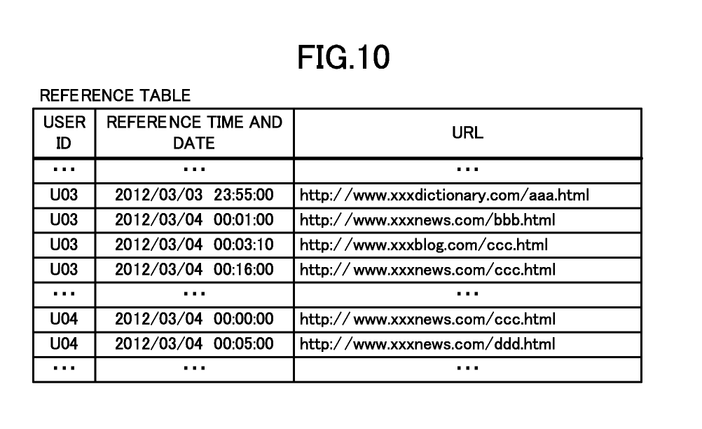

Now, various data used for the summary creating process are explained. The storage 190 stores the reference table shown in FIG. 10, in which a URL (uniform resource locator) of a document referred by the user who gave a comment to the program is saved. In the reference table, multiple data associated with a user ID of the user, the URL of the document made reference by the user, and a reference time and date at which the user made reference to this URL (hereinafter referred to as the “reference time and date”) are saved.

Here, note that the document that is referred by the user includes such as a webpage or a blog with contents from news, an encyclopedia, or a dictionary are inserted therein. Further, the sound recognition device 100 serves to function as a document server so that the sound recognition device 100 receives a transmission request of the document, the URL of the document with regard to the transmission request, and the user ID of the user who made the transmission request, which are respectively sent from the terminal devices 20 to 40. The sound recognition device 100 sends a reply along with the document requested for the transmission, and at the same time, stores an association of the user ID, a reply time and date to the request (in other words, the user reference time and date), and the URL of the document, which is stored in the reference table shown in FIG. 10.

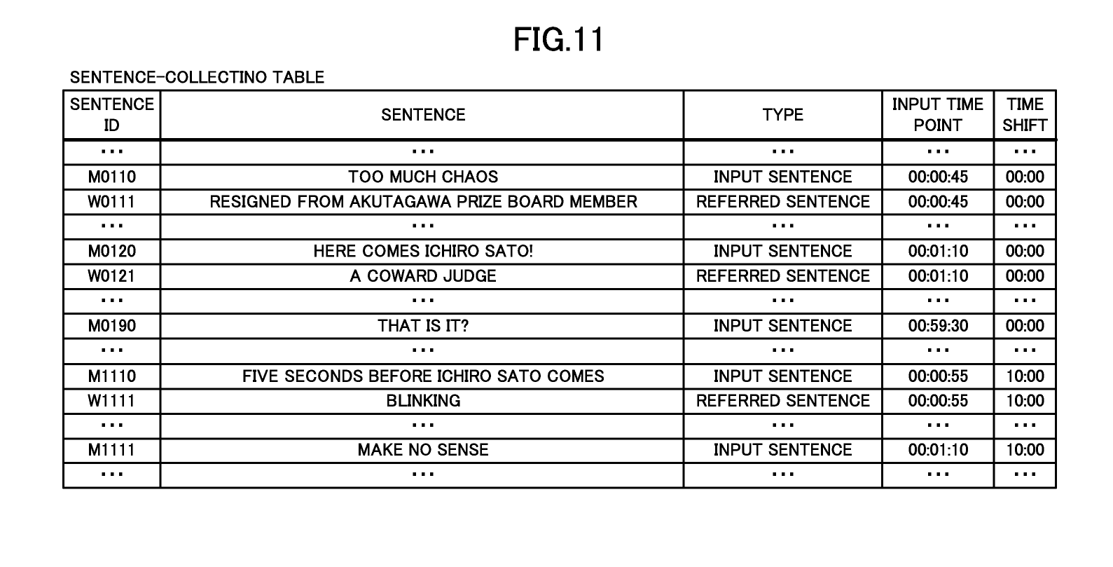

Further, the storage 190 stores the sentence-set table shown in FIG. 11, in which a set of sentences containing sentences relevant to the broadcast program as constituent element thereof is saved. Here, the sentences relevant to the program include sentences (hereinafter referred to as the “input sentence”) that constitute a comment on the broadcast program that is input, and sentences (hereinafter referred to as the “reference sentence”) that are inserted into the document referred by the commented user.

In the sentence-set table, if the sentence relevant to the program is the input sentence, then multiple data of an association of sentence ID for identifying the sentence, the sentence, a type of the sentence, a point at which an input of the sentence is made, and a time shift (hereinafter referred to as, the “time shift that corresponds to the sentence”), are saved.

Further, if the sentence relevant to the program included in the set of the sentences is the reference sentence, then multiple data of an association of a sentence ID for identifying the sentence, the sentence, a type of the sentence, a point at which the comment is input to retrieve the sentence, a time shift corresponding to the sentence, are saved in the sentence-set table.

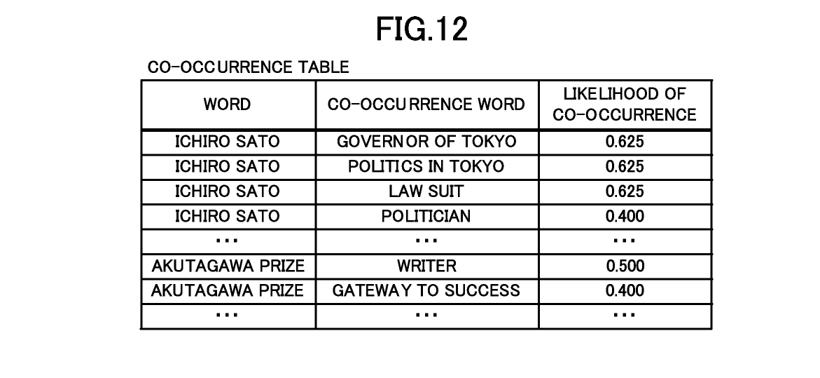

Further, the storage 190 stores the co-occurrence word table shown in FIG. 12, which saves words that are occasionally included in comments and documents, and co-occurrence words that are occasionally used along with the words included in the comments and documents. The co-occurrence word table saves multiple data associated with a word, co-occurrence of the word, a degree of likelihood (hereinafter referred to as the “likelihood of co-occurrence”) indicating a likelihood of the word and the co-occurrence word of being used together (in other words, being co-occurred) in the comment or in the document.

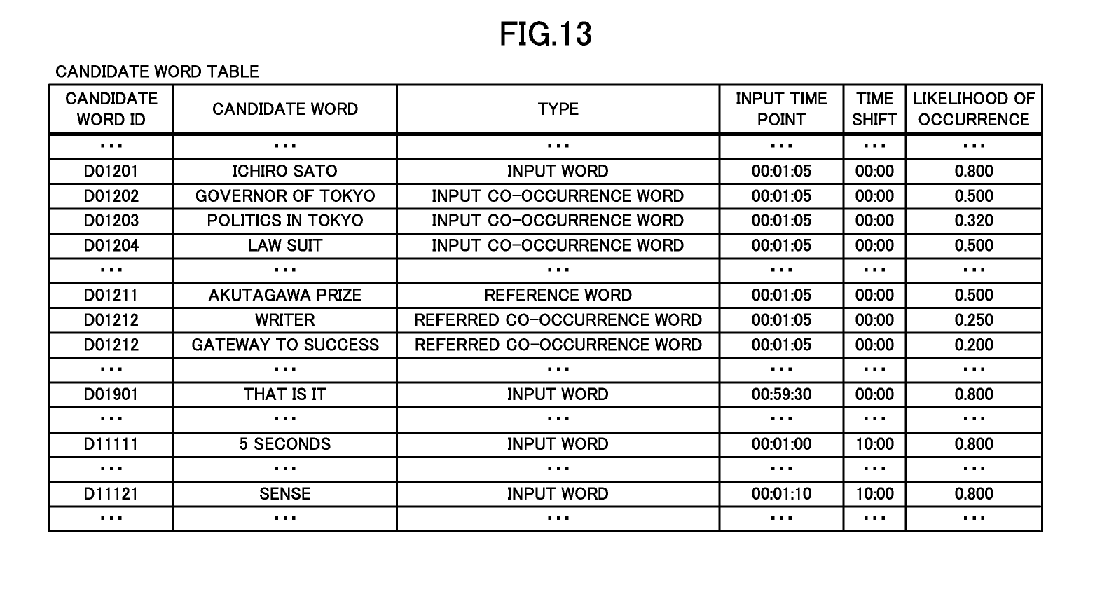

Further, the storage 190 stores the candidate word table shown in FIG. 13, in which the candidate words are saved. In this embodiment, the sound recognition device 100 uses words (hereinafter referred to as, the “input words”) contained in the input sentence, the words (hereinafter referred to as the “reference words”) that are contained in the reference sentence to which the user made reference at the time the input sentence is input, and the co-occurrence words (hereinafter referred to as the “co-occurrences of input word”, and the “co-occurrences of reference word”) of the input words and reference words, as candidate words to describe the dictation sound in the broadcast program.

Accordingly, if a candidate word is the input word, a candidate word ID for identifying the input word, the input word, a point at which an input sentence containing the input word is input (hereinafter referred to as the “time that corresponds to the input words”), a time shift that corresponds to a sentence that contains the input word (hereinafter referred to as the “time shift that corresponds to the input word”), and a likelihood of occurrence of the input word, are associated with each other and saved in the candidate word table. Here, the likelihood of occurrence is a value that indicates the likelihood of the candidate words to occur in a dictation given during the program under the condition which is given by an input of a comment that is used to extract the candidate words.

Further, if the candidate word is the reference word, then a candidate ID of the reference word, the reference word, a point at which an input of a comment that is used for retrieval of a sentence containing the reference word (hereinafter referred to as the “input time that corresponds to the reference word”), a time shift that corresponds to a sentence containing the reference word (hereinafter referred to as the “time shift that corresponds to the reference word”), and a likelihood of occurrence of the reference word, are associated with each other and saved in the candidate word table.

Further, if the candidate word is a co-occurrence of input word, then a candidate word ID of the co-occurrence of input word, the co-occurrence of the input word, a point at which an input of the input word that is likely to be used along with the co-occurrence of the input word is made (hereinafter referred to as the “input time that corresponds to the co-occurrence of the input word”), a time shift that corresponds to a sentence containing the input word (hereinafter referred to as the “time shift that corresponds to the co-occurrence of input word”), and a likelihood of occurrence of the co-occurrence of the input word, are associated with each other and saved in the candidate word table.

Yet further, if the candidate word is the co-occurrence of the reference word, then a candidate word ID of the co-occurrence of the reference word, the co-occurrence of the reference word, a point at which an input is made in correspond to the reference word that is likely to be used along with the co-occurrence of the reference word (hereinafter referred to as the “input time that corresponds to the co-occurrence of the reference word”), a time shift that corresponds to a sentence containing the reference word (hereinafter referred to as the “time shift that corresponds to the co-occurrence of the reference word”), and a likelihood of occurrence for the co-occurrence of the reference word, are associated with each other and saved in the candidate words table.

Further, the storage 190 stores an acoustic model, a word dictionary, and a language model which are used for recognizing a sound included in the program. The acoustic model depicts frequency patterns of phonemes and syllables, and resolves the sound uttered during the program into arrays (hereinafter referred to as the “phoneme and the like row”) of phonemes or syllables (hereinafter referred to as the “phoneme and the like”). The word dictionary is a dictionary that provides multiple associations of a word with the phoneme and the like row that indicates pronunciation of the word. The language model specifies a chain of words, which may be a bigram model that specifies a chain of two words, a trigram model that specifies a chain of three words, or an N-gram model that specifies a chain of N number of words.

Further, the storage 190 stores a degree of coincidence data, which indicates how probable a sound emitted at a particular dictation time point coincides with a sound used for a comment that is input at a particular time point. The degree of coincidence data gives a degree of coincidence curve that depicts a transition of the degree of coincidence according to a change in a difference (hereinafter referred to as the “time point difference”) obtained by subtracting the dictation time point from the input time point.

The degree of coincidence curve stored in the storage 190 includes a degree of coincidence for live broadcast, and a degree of coincidence for re-broadcast. The degree of coincidence curve for live broadcast depicts a degree of coincidence between the sound that is live broadcasted during the program, and the sound relevant to the comment that is input during the program broadcast. The degree of coincidence curve for re-broadcast depicts a degree of coincidence between a sound that is contained in the re-broadcasted program, and the sound relevant to the comment that is input during the re-broadcast of the program.

Dotted lines found on the degree of coincidence curve of re-broadcast indicates that the degree of coincidence is greater than that of the curve of live broadcast over a range of time point differences between a predetermined value “−TD1” and equal to or less than a predetermined value “+TD2”. The viewer who has previously viewed the program by live broadcast, or the viewer who has viewed the same program over by re-broadcast certainly know in advance what sounds are contained in the program that will be broadcasted. Therefore, these viewers tend to input comments at the time points that are closer to the time points at which the sounds relevant to the comments are uttered, compared to first time viewers of the live broadcasted program.

Further, the degree of coincidence for live broadcast curve has a peak at a time point difference of “TP”, and that the curvature decays as farther away from the time point difference “TP”. This is attributed to the nature of the live broadcasting that the comments are most often input after the sounds of the performer are heard. Note, however, that the performer may occasionally reply to the comments that are input, whereby a positive time point difference is not always obtained (in other words, the time point of the comment input may be delayed from the time point at which the sound is emitted).

Furthermore, the degree of coincidence curve for re-broadcast has a peak at a time point difference of “zero”, and that the curvature decays away as farther away from the time point difference of “zero”. As discussed, this is due to the viewer who has, for example, previously viewed the program in live broadcast tend to input comments more often at the same time these viewers hear the sounds relevant to the comments.

Here, operations of the CPU 101 that are carried out in the input 120, the saver 130, the output 140, the extractor 150, and the sound recognizer 160 shown in FIG. 4 are explained.

After completion of the broadcasting, the user of the sound recognizer 100 operates on the keyboard 109 shown in FIG. 2 to send an instruction to create a summary text that describes content of the sounds contained in the program that is broadcasted (hereinafter referred to as the “summary creating instruction operation”), and an instruction to specify a path to the multimedia data of the broadcast program, for which the summary is created (hereinafter referred to as the “path specification operation”).

The CPU 101 of the sound recognition device 100, initiates execution of the summary creating process shown in FIG. 9 when a signal that corresponds to the summary creating instruction operation is input on the keyboard 109.

The input 120 inputs the signal that is output from the keyboard 109 to identify a path (hereinafter referred to as the “specified path”) that is specified by the path specification operation based on the signal that is input (step S61).

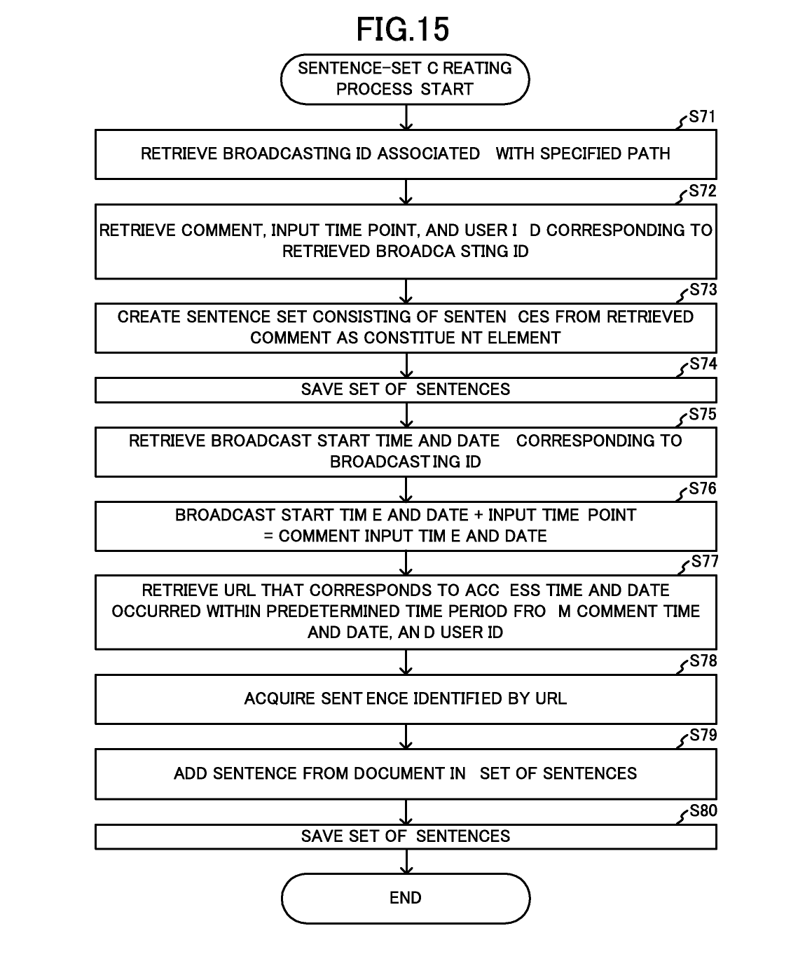

Further, the extractor 150 executes the sentence-set creating process shown in FIG. 15, to create a set of sentences consisted of sentences relevant to the program that is represented by multimedia data found within a path, as constituent elements (step S62).

As soon as the sentence-set creating process is established, the extractor 150 retrieves the broadcasting ID associated with the specified path, through the entire broadcasting table shown in FIG. 5 (step S71).

Further, the extractor 150 retrieves a comment that is associated with a retrieval ID, a time point of input, and a user ID for the each retrieved broadcasting ID (hereinafter referred to as the “retrieval broadcasting ID”) through the entire comment table shown in FIG. 6 (step S72). Accordingly, the extractor 150 is able to identify the comment that is input when the program represented by the media data in the specified path is live broadcasted or re-broadcasted, the user who gave this comment, and the time point at which the comment is input which is expressed by the elapsed time from the time and date of broadcast.

Then, the extractor 150 acquires sentences that constitute the comment (in other words, the input sentences) for all retrieved comments (hereinafter referred to as the “retrieved comments”), and make the acquired input sentences into sentences relevant to the broadcast program that is represented by the specified multimedia data. Further, the extractor 150 creates a set of sentences consisted of input sentences as constituent elements (step S73).

Afterwards, the extractor 150 retrieves a time shift associated with the broadcasting ID for each retrieved broadcasting ID through the broadcasting table shown in FIG. 5. The extractor 150 then creates a sentence ID of the input sentence. Further, the retrieved time shift is adopted as a time shift that corresponds to the input sentence of the retrieved comment by using the same broadcasting ID.

Further, the extractor 150 saves the created sentence ID, the sentences, a type of the sentence, a time point at which an input of the comment constituted by these sentences is made, and a time shift that corresponds to the sentences, are associated with each other and saved in the sentence-set table shown in FIG. 11 (step S74).

The reason why the time shift is made an association with the input sentences extracted from the comment is that a timing of the comment input in relation to a timing of the sound output is likely to deviate in correlation to the time shift. Hence, the time shift must be associated with the input sentence for the later processes.

Further, the extractor 150 retrieves broadcast start time and dates that are associated with the broadcasting ID, for each broadcasting ID retrieved in the step S71 from the broadcasting table shown in FIG. 5 (step S75).

Further, the extractor 150 identifies the time and date at which the comment is input (hereinafter referred to as the “comment input time and date”) by adding the retrieved broadcast start time and date to the time point at which the input is made, for each comment retrieved in the step S72 (step S76).

Further, the extractor 150 calculates a time interval (hereinafter referred to as the “comment input time period”) from the time and date that is earlier than the comment input time and date by a predetermined time A, to a time and date that is later than the comment input time and date by a predetermined time B. The extractor 150 then retrieves URLs that are associated with the reference time and date contained in the comment input time period, and the user ID retrieved in the step S72, from the reference table shown in FIG. 10 for each comment retrieved in the step S72 (step S77). Accordingly, the extractor 150 identifies a document that the user made reference when the comment is input, and uses the identified document as a user referred page to input the comment. Note that suitable predetermined time A and time B may be obtained by an experiment conducted by one of ordinary skill in the art.

Further, the extractor 150 acquires documents contained in the URL for every URL retrieved in the step S76 (step S78).

After that, the extractor 150 acquires sentences (hereinafter referred to as the “referred sentences”) that are inserted in the referred document, for every acquired document, and uses the acquired referred sentences as sentences that are relevant to the broadcast program represented by specified multimedia data. Further, the extractor 150 adds the referred sentences to the set of sentences (step S79).

This is due to the fact that the document referred by the viewer, for example, while viewing the program frequently contain topics that are relevant to the broadcast program such as the topics the viewer feels curious about or wants to make clear about, in the contents of the broadcasted program.

Further, the extractor 150 terminates the sentence-set creating process after saving the referred sentences in the sentence-set table shown in FIG. 11 (step S78). In particular, the extractor 150 creates a sentence ID of the referred sentence, and the created sentence ID, the sentence, a type of the sentence, a time point at which an input is made for the comment used to retrieve the document containing the sentence, a time shift that corresponds to the sentence, are associated with each other and saved in the sentence-set table.

Note that the referred sentence extracted from the referred document is associated with the time shift for the reason that a reference timing of the document in relation to a timing of a sound output is likely to deviate in correlation to the time shift. Hence, it is necessary to have the referred sentence and the time shift to be associated with each other for a later process.

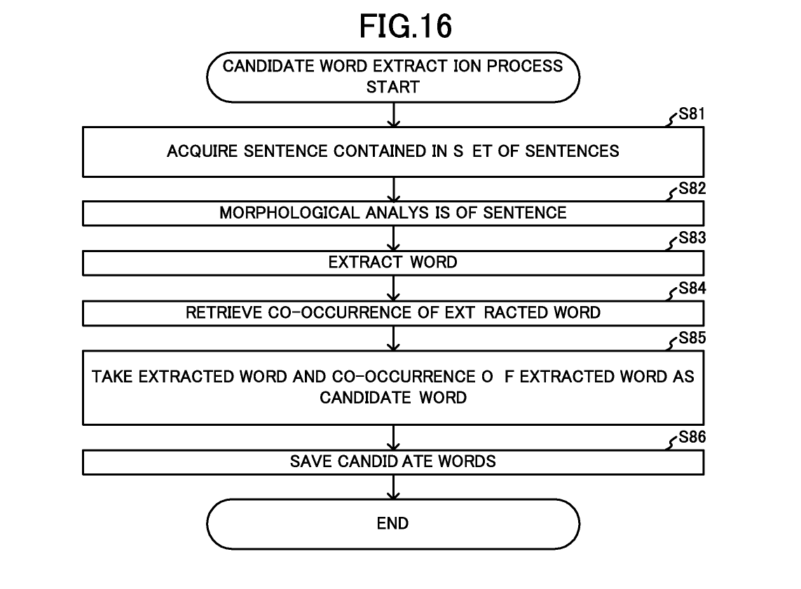

After the step S62 shown in FIG. 9, the candidate words extraction process shown in FIG. 16 is executed, in which the extractor 150 extracts candidate of words (that is, the candidate words) from the sentences contained in the sentence set; the candidate words describe the sound emitted on the broadcasted program (step S63).

As the candidate words extracting process is initiated, the extractor 150 acquires all the sentences contained in the sentence set (step S81). Further, the extractor 150 performs morphological analysis on each acquired sentence (step S82). Accordingly, the extractor 150 is able to extract all the words (that is, the input words) that constitute the input sentence, and all the words (that is, the reference words) that constitute the referred sentence, from each sentence (step S83).

The extractor 150 then retrieves a co-occurrence word (that is, the co-occurrence of input word) associated with the input word for each extracted input word through the co-occurrence word table shown in FIG. 12. Further, if the input word is input as part of the comment to the program, then the extractor 150 uses the co-occurrence of the input word as a word that is likely to be used (in other words, co-occurring in the dictation) in the dictation given by the performer of the broadcast program.

Further, the extractor 150 retrieves a co-occurrence word that is associated with the reference word (that is, the co-occurrence of reference word) for each extracted reference word through the co-occurrence word table (step S84). Then, if the viewer makes reference to the co-occurrence of the reference word in preparation of a comment on the broadcast program, then the extractor 150 uses the co-occurrence of the reference word that is retrieved based on the reference word as a word that is likely to be contained in the dictation given by the performer of the broadcast program.

After that, the extractor 150 uses the input word and the reference word extracted in the step S83, and the input co-occurrence word and co-occurrence the reference word retrieved in the step S84, as candidate words (step S85).

The extractor 150 terminates the execution of the candidate word extracting process after saving the candidate words in the candidate word table shown in FIG. 13 (step S86).

In particular, the extractor 150 creates a candidate word ID for identifying the candidate word for each candidate word. The extractor 150 then adopts each input time point of the input word, a co-occurrence of the input word, and a reference word inserted in the document that is retrieved based on the comment containing this input word, and an input time point corresponding to a co-occurrence of the reference word, as an input time point of an input sentence, from which the input word is extracted.

The candidate word ID of the candidate word that is the input word, the candidate word, a type of the candidate word, an input time point that corresponds to the candidate word, a time shift associated with the input sentence containing the candidate word, are associate with each other and saved in the candidate word table by the extractor 150. Further, a candidate word ID of candidate word that is the co-occurrence of the input word, the candidate word, a type of the candidate word, an input time point corresponding to the candidate word, a time shift corresponding to input word that is likely to co-occur, are associated with each other and saved in the candidate word table by the extractor 150. Further, a candidate word ID of candidate word that is the reference word, the candidate word, a type of the candidate word, an input time point corresponding to the candidate word, a time shift corresponding to the referred sentence containing the candidate words, are associate with each other and saved in the candidate word table by the extractor 150. Furthermore, candidate word ID of a candidate word that is the co-occurrence of reference word, the candidate word, a type of the candidate word, an input time point corresponding to the candidate word, time shift corresponding to the reference word that is likely to co-occur, are associated with each other and saved in the candidate word table by the extractor 150.

After candidate words are extracted in the step S63 shown in FIG. 9, the sound recognizer 160 shown in FIG. 4 calculates a likelihood of occurrence for each candidate word (step S64).

Here, an example of a process in the step S64 is explained. The sound recognizer 160 retrieves every candidate word that is saved in the candidate word table shown in FIG. 13. The sound recognizer 160 then assigns a first predetermined value of a likelihood of occurrence for each candidate word, that is, the input word. This first predetermined value indicates how likely the input word occurs in sounds from the broadcast program in the form such as a dictation of the input word that is given during the program, under the condition which the input word is input as part of the program comment.

Further, the sound recognizer 160 assigns a second predetermined value of a likelihood of occurrence for each candidate word, that is, the reference word. This second predetermined value indicates how likely this reference word occurs in the sounds from the program under the condition where the comment used for retrieval of the reference word is input as part of the comment to the broadcast program. One of ordinary skill in the art may certainly conduct an experiment to obtain suitable values for the first predetermined value and the second predetermined value.

Further, the extractor 150 retrieves a likelihood of co-occurrence for the input word and the co-occurrence word among the candidate words, from the co-occurrence word table shown in FIG. 12, wherein the likelihood of co-occurrence is retrieved per association of the input word with the co-occurrence word. The extractor 150 then assigns an adjusted value of the aforementioned first predetermined value (hereinafter referred to as the “first adjusted value”) to a likelihood of occurrence for the co-occurrence word, by using the retrieved likelihood of co-occurrence. The first adjusted value indicates how likely the co-occurrence word occurs in the dictation given during the program under the condition which the comment containing the input word is input. Thus, the higher the likelihood of co-occurrence the greater the adjusted value becomes.

The extractor 150 retrieves a likelihood of co-occurrence for the input word and the co-occurrence word among the candidate words, from the co-occurrence word table shown in FIG. 12, wherein the likelihood of co-occurrence is retrieved per association of the input word with the co-occurrence word. The extractor 150 then assigns an adjusted value of the aforementioned second predetermined value (hereinafter referred to as the “second adjusted value”) to a likelihood of co-occurrence of the co-occurrence word, by using the retrieved likelihood of co-occurrence. The second adjusted value indicates how likely the co-occurrence word occurs in the dictation during the program under the condition which the comment used for retrieval of the reference word is input. Thus, the higher the likelihood of co-occurrence, the greater the adjusted value becomes.

After the step S64 shown in FIG. 9 is carried out, the input 120 reads out predetermined sized multimedia data from a specified path that is identified in the step S61 (step S65).

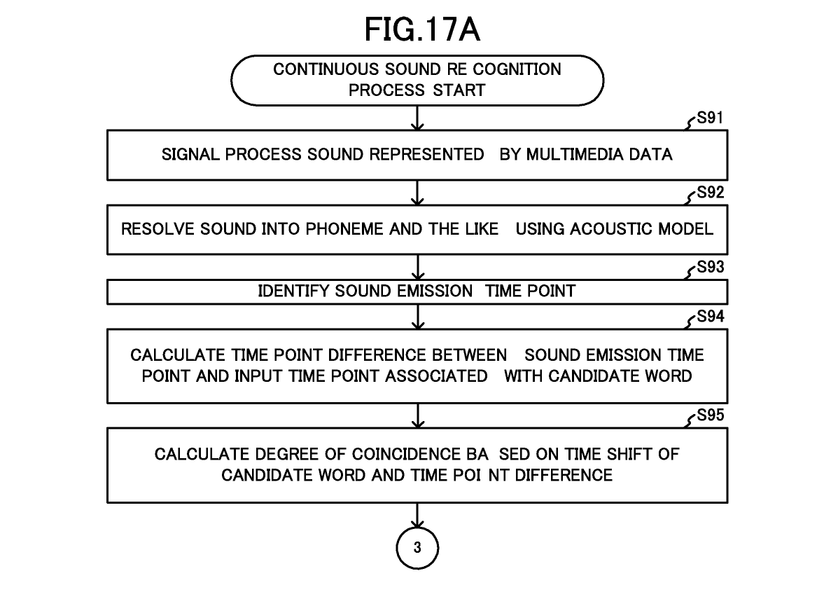

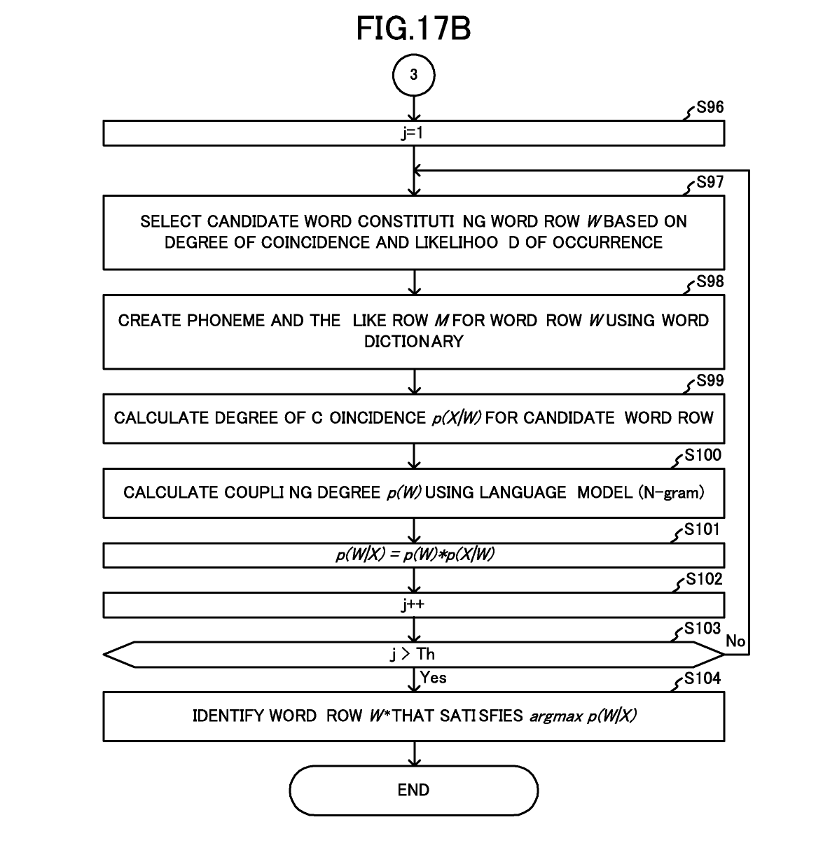

The sound recognizer 160 shown in FIG. 4 then executes the continuous sound recognition process shown in FIG. 17A and FIG. 17B, in which the sound recognizer 160 recognizes a sound (hereinafter referred to as the “program sound”) X from the broadcast program represented by multimedia data that is read out in the step S65 (step S66).

Due to the continuous sound recognition process being described in Non-Patent Literature 1, simply a schematic explanation thereof is made in the following.

The continuous sound recognition process involves retrieving a row of words W* which maximizes a probability p(W|X) expressing the content of the program sound X with a row of words W, when a sound (hereinafter referred to as the “program sound”) X from the broadcast program that is read out in the step S65 is input.

Here, the probability p(W|X) may be rewritten using the Bayes theorem as Formula (1) given below.

$$\begin{matrix}[ Formula 1 ] & \\ p ( W \vert X ) = \frac{p ( W ) \times p ( X \vert W )}{p ( X )} & ( 1 )\end{matrix}$$

Here, the probability p(X) in the denominator can be disregarded as to it is considered as a normalization coefficient giving no effect on determination of the row of words W.

Accordingly, the row of words W* that maximizes the probability p(W|X) expressed in Formula (2) below may also be written as Formula (3) or Formula (4) given below.

[Formula 2]

W*=arg max p(W|X) (2)

[Formula 3]

W*=arg max p(W)×p(X|W) (3)

[Formula 4]

W*=arg max{log p(W)+log p(X|W)} (4)

In this embodiment, the sound recognizer 160 is explained by assuming that the sound recognizer 160 retrieves the row of words W* that satisfies Formula (3), yet the invention is not limited to this particular embodiment, and that the sound recognizer 160 may certainly retrieve the row of words W* that satisfies Formula (4).

As soon as the sound recognition process is established, the sound recognizer 160 performs a signal process to extract a sound (hereinafter referred to as the “program sound”) from the broadcast program from a sound signal of the sound represented by multimedia data read out in the step S65 shown in FIG. 9, based on, for example, a frequency and a sound pressure (step S91).

The sound recognizer 160 then creates a sequence equation of phoneme X={x₁, x₂, . . . xₖ} that describes the program sound X, by resolving the phoneme and the like of the program sound X, by matching a frequency change of the extracted program sound X and a frequency pattern of the phonemes and syllables that are described by the acoustic model stored in the storage 190 (step S92).

The sound recognizer 160 then identifies a time point at which the program sound X is emitted, and describes the time point using an elapsed time from a broadcast start time and date to the emission of the sound (step S93).

Further, the sound recognizer 160 calculates a difference (that is, the time point difference) found between an input time point associated with the candidate word, and the time point at which the extracted program sound is emitted, for every candidate word saved in the candidate word table shown in FIG. 13 (step S94).

The sound recognizer 160 then retrieves the time shift that corresponds to the candidate word for every candidate word saved in the candidate word table shown in FIG. 13. The sound recognizer 160 further calculates the degree of coincidence for the candidate words having the time shifts that are equal to or less than a predetermined value, based on the time point difference obtained in the step S94 and the degree of coincidence curve of live broadcast obtained by the data saved in the storage 190. The sound recognizer 160 further calculates the degree of coincidence for candidate words having the time shifts greater than the predetermined value, based on the obtained time point difference in addition to a degree of coincidence curve of re-broadcast calculated using the data saved in the storage 190 (step S95).

Then, the sound recognizer 160 initializes a variable j used for calculations of numbers in the created row of words W as taking a value “zero” (step S96).

Further, the sound recognizer 160 selects candidate words w₁ to wₖ, that constitute the row of words, W={w₁, w₂, wₖ}, wherein the candidate words with greater degree of coincidence are selected with higher probability. Yet further, the sound recognizer 160 selects candidate words w₁ to wₖ constituting the aforementioned row of words W, at which the candidate words with the greater likelihood of occurrence are selected with higher probability. Afterwards, the sound recognizer 160 creates the row of words W constituted by the selected candidate words w₁ to wₖ (step S97). Here, note that the number of candidate words k that constitutes the row of words W is stochastically determined during the execution of the step S97.

The sound recognizer 160 then uses the word dictionary stored in the storage 190 to create a sequence equation of phoneme for each candidate word constituting the row of words W, and obtain a sequence equation of phoneme, M={m₁, m₂, . . . , mᵢ}, which rendering the pronunciation of the row of words W (step S98).

Further, the sound recognizer 160 calculates a probability p (X|W) of the occurrence of the program sound X in the row of words W using Formula (5) given below (step S99). Here, note that the probability p (X|W) is referred as a degree of coincidence because this probability indicates how often a sequence equation of phoneme that describes the row or words X matches a sequence equation of phoneme of the program sound.

$$\begin{matrix}[ Formula 5 ] & \\ p ( X \vert W ) = {\prod }_{i} p ( {x}_{i} \vert {m}_{i} ) & ( 5 )\end{matrix}$$

Here, note that the sound recognizer 160 makes a comparison between sound characteristics of phoneme and the like mᵢ that is defined by the acoustic model, and sound characteristics of phoneme and the like xᵢ that is resolved by an audio signal, to find how often these two coincide. The greater the degree of coincidence, the value that is closer to “one” is taken for p(xᵢ|mᵢ), while, the more disagreement there is, the value that is closer to “zero” is taken for p(xᵢ|mᵢ).

Further, by using Formula (5) given below, the sound recognizer 160 calculates a degree of coupling p(W) indicating a linguistic probability that is irrelevant to the program sound X, which also indicating a probability of occurrence of the row of words W at the time when the program sound X is input. In this, the sound recognizer 160 approximates Formula (6) with Formula (7) given below to obtain an approximate value for the degree of coupling p(W) using an N-gram language model (step S100). This approach is applied due to reduction of the computational complexity.

$$\begin{matrix}[ Formula 6 ] & \\ p ( W ) = {\prod }_{i} p ( {w}_{i} \vert {w}_{1} , … {w}_{i - 1} ) & ( 6 ) \\ [ Formula 7 ] & \\ p ( {w}_{i} \vert {w}_{1} … {w}_{i - 1} ) ≅ p ( {w}_{i} \vert {w}_{i - N + 1} , … {w}_{i - 1} ) & ( 7 )\end{matrix}$$

Further, the sound recognizer 160 obtains p(W|X) by multiplying p(X|W) that is calculated in the step S99 by the degree of coupling p(W) calculated in the step S100 (step S101).

Further, the sound recognizer 160 determines whether the variable j is greater than a predetermined value Th (step S103) after incrementing the variable j by value of “one” (step S102). Here, if the sound recognizer 160 determines the variable j is equal to or less than the predetermined value Th (step S130: Yes), then returns to the step S97 to again perform the above processes. Note that one of ordinary skill in the art may define a suitable value for the predetermined value Th by conducting an experiment.

On the other hand, if the variable j is greater than the predetermined value Th (step S130: No), then the sound recognizer 160 identifies a row of words W* that maximizes p(W|X) (in other words, that satisfies Formula (2) and Formula (3)) out of the Th ways of different rows of words W that are obtained (step S104). Then, the continuous sound recognition process is terminated.

After the continuous sound recognition process in the step S66 shown in FIG. 9 is performed, the sound recognizer 160 adds the recognized row of words W* to the summary (step S67).

After that, the input 120 shifts a read-out position of the aforementioned electronic file within the path in backward just by the size of the read-out multimedia data. The input 120 then determines whether the read-out position is the EOF, the end of the electronic file (step S68). In this, if the input 120 determines the read-out position is not the EOF (step S68: No), then the processes from the step S65 are again performed.

In the step S68, if the input 120 determines that the read-out position is the EOF (step S68: Yes), then the output 140 outputs the summary to the video card 107 shown in FIG. 2 (step S69). The video card 107 then displays the summary on the LCD 108.

Further, the output 140 terminates the summary creating process after the specified path, and the text describing the summary of the sound that is represented by the multimedia data in the specified path, are associated with each other and saved in the storage 190 (step S70). This is implemented so that the multimedia data can be retrieved based on keywords.

Here, the comment on the dictation that is output via playing the multimedia data frequently includes words describing the content of the dictation or the co-occurrences of these words. Thus, in the aforementioned approaches, the sound recognition device 100 is capable of more suitably recognizing the sounds than the conventional approaches because the sound recognition device 100 uses both the words that constitute the comment (that is, the input words) and the co-occurrence words of these words (that is, the co-occurrence of the input words) as the candidate of words describing the content of the sounds (that is, the candidate words). Therefore, the sound recognition device 100 is capable of more suitably recognizing the sounds contained in the multimedia data compared to that of the conventional approaches, due to the utilization of the comment attached to the multimedia.

Further, the user who apparently inputs the comment on the sounds from the broadcast program, often makes a research through the documents to find the meaning of the dictation. Hence, the documents that are viewed by the user who had listened to the multimedia data and input the comment frequently contain the words describing the content of the sounds emitted via playing the multimedia data, or the co-occurrence words of these words. Thus, according to the aforementioned approaches, the sound recognition device 100 is capable of providing more suitable recognition of the sounds than that of the conventional approaches. This is due to the fact that the words constituting the user referred documents (that is, the reference words) and the co-occurrence of these words (that is, the co-occurrence of reference words) are adopted as the candidates of words that describe the content of the sounds (that is, the candidate words).

Yet further, according to those aforementioned approaches, the sound recognition is achieved based not only on the degree of coincidence between the phoneme that is recognized in the sound and the phoneme that denotes the pronunciation of the candidate words, but also achieved based on the likelihood of occurrence of the candidate words, whereby a more accurate sound recognition is achieved compared to the sound recognition obtained by the conventional sound recognition devices which perform recognition of sounds based simply on the degree of coincidence.

Here, typically, the time point at which the sound is emitted and the time point at which the comment on the sound is input have tendency to coincide with each other, as in the most cases, the time discrepancies rarely stretches beyond the predetermined period of time. Hence, the sound recognition device 100 is capable of performing more accurate sound recognition than that of the conventional approaches since the sound recognition is implemented based on the degree of coincidence between the input time point that corresponds to the candidate words, and the time point at which the sound is emitted, and also the comment that contains these candidate words.

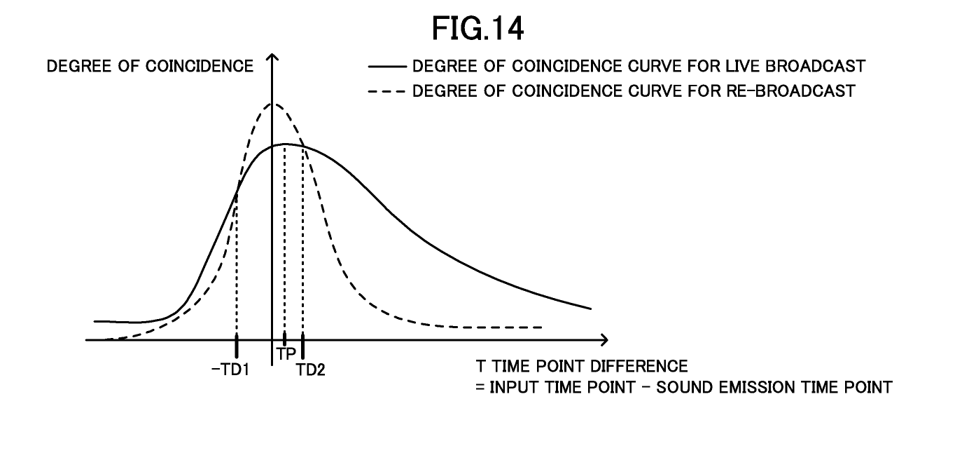

Here, as discussed above, the viewer who has previously viewed the program in live broadcast, or the viewer who has viewed the same program again by the re-broadcast, are more likely to input comments at the time point that is closer to the point at which the sound relevant to the comment is emitted, in comparison to the first time viewer of the live broadcast program. FIG. 14 shows that the degree of coincidence curve of the re-broadcast stored on the sound recognition device 100 lies above the degree of coincidence curve of live broadcast over the range of time point differences between “−TD1” and “TD2”. Thus, as for the same candidate words, if the time point differences of the same value that fall within the range between “−TD1” and “TD2” can be obtained, then there is a higher probability that the input word or reference word that are input or referred during the re-broadcast, or the co-occurrence of these words to be used in the row of words W that is created in the continuous sound recognition process shown in FIG. 17A and FIG. 17B, in comparison to the words or the co-occurrence of the words that are input during the live broadcast.

Further, as discussed above, the viewer who has previously viewed the broadcast program by live broadcast is more likely to input a comment at the time point that is closer to the time point at which the sound that is relevant to the comment is uttered. In addition, as shown in FIG. 14, the degree of coincidence curve of re-broadcast stored on the sound recognition device 100 shows that the curve has its peak at the time point “zero”, and the curve decays away as farther distance away from the time point “zero”. Thus, as for the same candidate words, if these words are input words that are input during the re-broadcast, or the co-occurrences of these words, then there is a higher probability that the words having less time discrepancy between the time point of sound emission and the input time point, to be used in the row of words W that is created by the continuous sound recognition process.

On the other hand, the viewer of the live broadcast is more likely to input comments on the sound after hearing the sound of the performer. The degree of coincidence curve of live broadcast stored on the sound recognition device 100 shown in FIG. 14 depicts that the curve has its peak at the time point difference “TP”, and decays away as farther distance away from the time point difference “TP”. Thus, as for the same candidate words, if these are the words input during the live broadcast, or the co-occurrence of these words, then there is a higher probability that the words having the time point difference closer to “TP” to be used in the row of words W that is created in the continuous sound recognition process. The time point difference is the difference between the time point at which the sound is emitted and the input time point. Therefore, the sound recognition device 100 is capable of performing more accurate sound recognition than that of the conventional approaches.

This embodiment has been explained by assuming internet is used for the communication network 10 shown in FIG. 1, yet the communication network 10 is not limited to internet; an LAN (local area network) or a public network may be used as alternatives.

Further, this embodiment has been explained by assuming that the multimedia data represents the video and sound of broadcast program, yet the multimedia data is not limited to such particular features; simply the sound of the broadcast program alone may be represented by the multimedia data.

### Embodiment 2

Likewise the sound recognition device 100 of Embodiment 1, the sound recognition device 200 of Embodiment 2 according to the present invention constitutes the sound recognition system 1 shown in FIG. 1. In the following, explanations with regard to similarities between Embodiment 1 and Embodiment 2 are omitted so as rather to focus on the differences between Embodiment 1 and Embodiment 2.

Hereinafter, an explanation on a hardware configuration in the sound recognition device 200 is omitted for the reason that the configuration being the same as that of the hardware on the sound recognition device 200 of Embodiment 1.

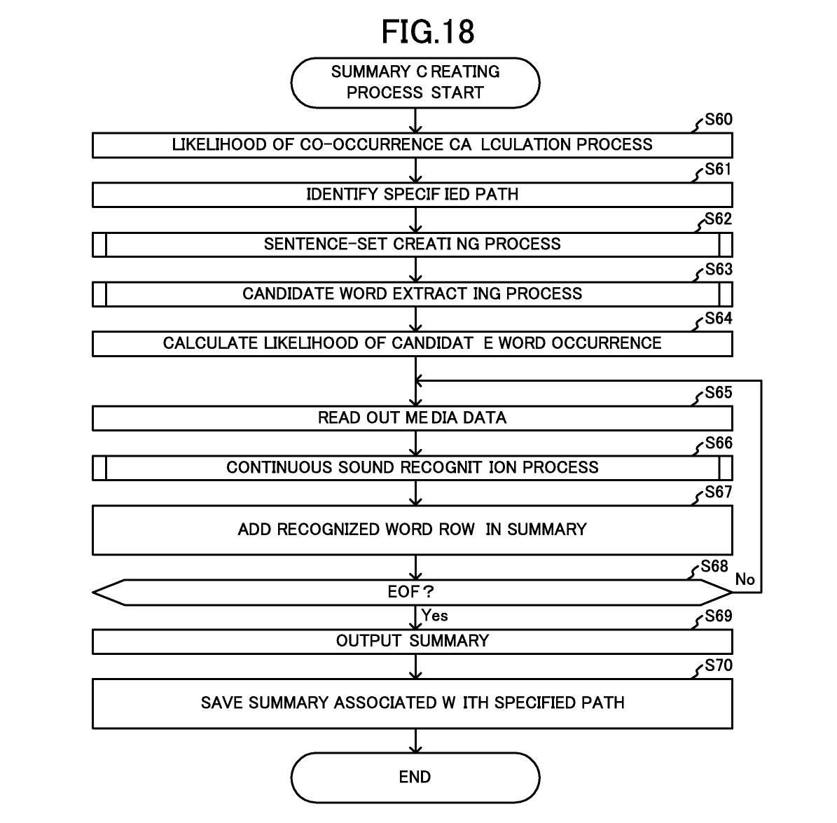

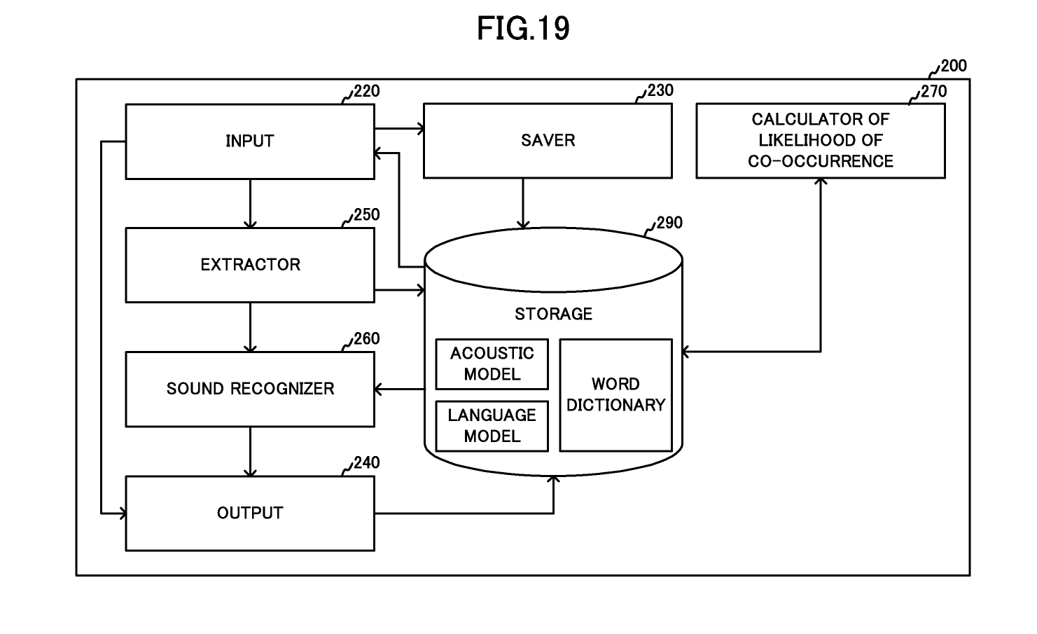

Now, functionalities of the sound recognition device 200 are explained. A CPU on the sound recognition device 200 of Embodiment 2 serves to function as an input 220, a saver 230, an output 240, an extractor 250, a sound recognizer 260, and a calculator of likelihood of co-occurrence 270 as shown in FIG. 19, by executing a summary creating process shown in FIG. 18. In addition, the CPU on the sound recognition device 200 functions as a storage 290 by working in synergy with the hard disc 104. The input 220, the saver 230, the output 240, the extractor 250, the sound recognizer 260, and the storage 290 serve the same functions as the input 120, the saver 130, the output 140, the extractor 150, the sound recognizer 160 and the storage 190, respectively, as discussed in Embodiment 1.

The calculator of likelihood of co-occurrence 270 calculates a likelihood of co-occurrence of a co-occurrence word for each user of the terminal devices 20 to 40. Here, the co-occurrence word is used along with a word inserted in the document that is referred by the users.

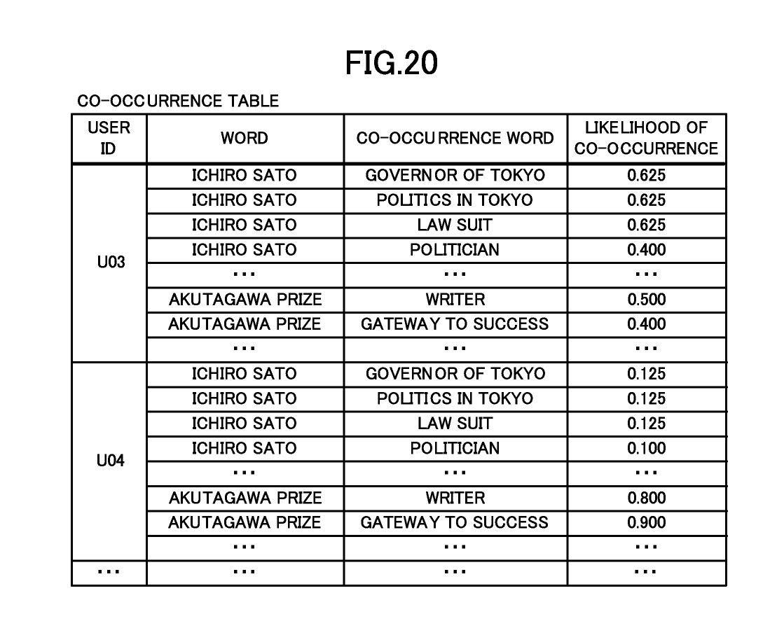

The storage 190 stores a co-occurrence word table shown in FIG. 20, which is in fact different from the co-occurrence word table shown in FIG. 12. Multiple data are saved in the co-occurrence word table, wherein the multiple data incorporate an association of a user ID, a word that is inserted in a document referred by the user of this user ID, a co-occurrence word of this word, and a likelihood (hereinafter referred to as the “degree of co-occurrence”) that indicates how likely the word and the co-occurrence word are being used together in a comment or in a document (that is to say, co-occurring).

Now, operations of the CPU performed in each entity of functions shown in FIG. 19 are explained.

The CPU on the sound recognition device 200 initiates execution of a summary creating process shown in FIG. 18 as soon as a signal indicating a summary creating instruction operation is input on the keyboard.

As soon as the summary creating process execution is established, the calculator of likelihood of co-occurrence 270 executes a likelihood of co-occurrence calculation process to obtain a likelihood of co-occurrence (step S60).

The likelihood of co-occurrence calculation process involves retrieving a URL that is associated with the user ID for each user ID saved in the reference table shown in FIG. 10. The calculator of likelihood of co-occurrence 270 acquires documents in the URL for every retrieved URL. Then, the calculator of likelihood of co-occurrence 270 calculates the number of co-occurrence that indicates how many times a co-occurrence word and an inserted word are being used together, for every acquired document. Here, the inserted word is the word inserted in the document and the co-occurrence word is the word that is used along with the inserted word in the document. Further, the calculator of likelihood of co-occurrence 270 calculates a likelihood of co-occurrence based on the number of co-occurrence for every combination of inserted word and co-occurrence word. As for the likelihood of co-occurrence having a value equal to or greater than a predetermined value, the calculator of likelihood of co-occurrence 270 associates the user ID, the inserted word, the co-occurrence word, and the likelihood of co-occurrence, then saves into the co-occurrence table shown in FIG. 20.

After the process in the step S60 shown in FIG. 18 is executed, then processes from step S61 to the step S63 are executed.

After that, the sound recognizer 260 calculates the likelihood of occurrence for each candidate word (step S64). At this point, if the candidate word is the co-occurrence of the input word, then the sound recognizer 260 identifies a user ID of the user who made an input of an input word that is co-occurring with the co-occurrence of the input word. The sound recognizer 260 further retrieves a likelihood of co-occurrence for the association of the identified user ID, the input word, and the co-occurrence of the input word, which are associated with each other in the co-occurrence table shown in FIG. 20. After that, the sound recognizer 260 calculates the likelihood of occurrence using the retrieved likelihood of co-occurrence. Now, if the candidate word is the co-occurrence of reference word, then the sound recognizer 260 identifies a user ID of the user who made reference to the reference word that is co-occurring with the co-occurrence of the reference word, and retrieves the likelihood of co-occurrence for the association of the identified user ID, the reference word, and the co-occurrence of the reference word, which are associated with each other in the co-occurrence table shown in FIG. 20. Furthermore, the sound recognizer 260 calculates a likelihood of occurrence by using the retrieved likelihood of co-occurrence.

The summary creating process is terminated after the processes from the step S65 to the step S70 are executed by the sound recognizer 260.

According to the aforementioned approaches, the sound recognition device 200 calculates the likelihood of co-occurrence based on the number of co-occurrence occurred between the inserted word and the co-occurrence word in the document, wherein the inserted word is the word inserted in the document referred by the user, and the co-occurrence word is the word that is used along with the inserted word in the document. Further, the sound recognition device 200 calculates a likelihood of occurrence on the co-occurrence word of the word referred by or input by the viewer, by using the calculated likelihood of co-occurrence. Then the sound recognition device 200 recognizes the sound based on the calculated likelihood of occurrence of the co-occurrence word, and also the degree of coincidence between the pronunciation of the co-occurrence word and the sound. Here, the words that are used in co-occurrence with one another in the comments by the viewers, or the words that are inserted in co-occurrence with one another in documents may indeed change by the subject of the matter, the fashion and style of the time period, and also by preference of the viewer. However, the sound recognition device 200 is capable of accurately recognizing the sounds even if the subject of the matter, the style and fashion of the time, the preferences of the viewer may be changed.

### Embodiment 3

As discussed, the sound recognition device 100 of Embodiment 1 creates a comment synthesized video in the step S17 as shown in FIG. 3B, and outputs multimedia data representing the comment-synthesized video to the LAN card 106 shown in FIG. 2 in the step S19. As is also discussed, the LAN card 106 transmits the multimedia data to the terminal devices 20 and 30, and further, the terminal devices 20 and 30 display the comment synthesized video in the video display area AM on the viewer screen shown in FIG. 7.

However, a sound recognition device of Embodiment 3 does not in fact create a comment synthesized video in the step S17 as shown in FIG. 3B, but outputs multimedia data and comment data to the LAN card 106 in the step S19. The LAN card 106 then transmits the multimedia data and the comment data to the terminal device.

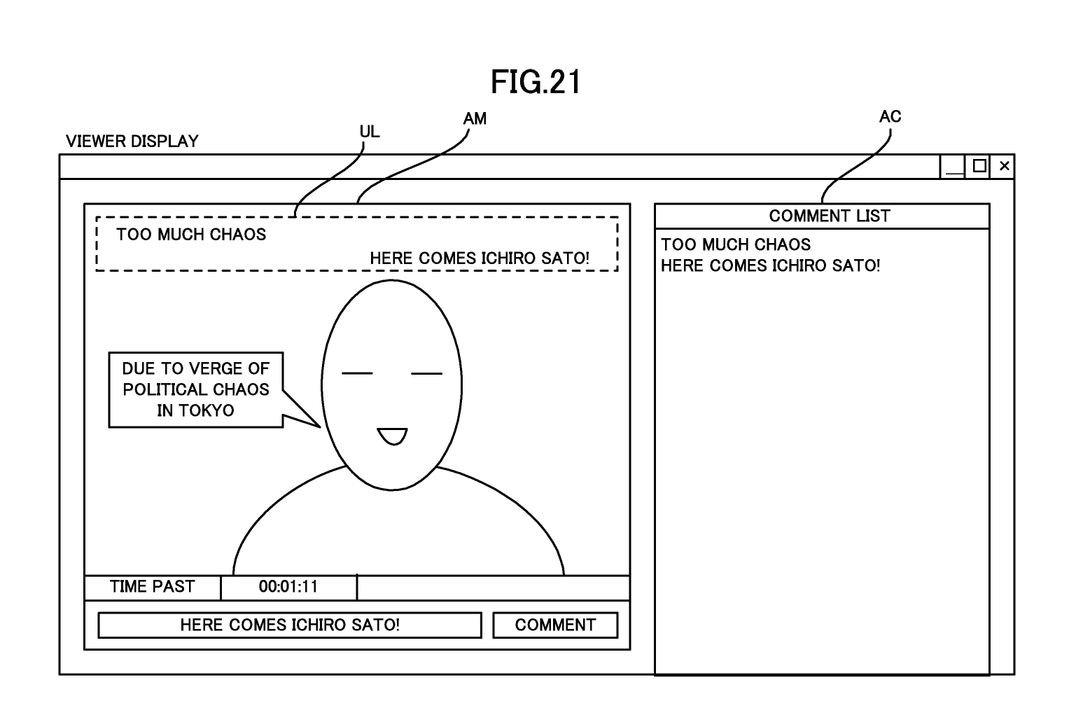

The terminal device used in Embodiment 3 displays a viewer screen as shown in FIG. 21. This viewer screen includes the video display area AM as discussed in Embodiment 1, a comment display area AC, and a comment display section that is layered onto the video display area AM (in other words, the higher ranked layer over the video display area AM). When the multimedia data and comment data are received, the terminal device displays a video represented by the multimedia data in the video display area AM. Further, the terminal device displays the comment represented by the comment data in both the comment display section UL that is layered onto the video display area AM, and in the comment display area AC. Note that a frame on the comment display section UL is drawn with dotted lines for the sake of simplification in preparation of the figure, yet the frame on the comment display section UL will not be displayed on the viewer screen.

### Embodiment 4

The sound recognition device 100 of Embodiment 4 distributes broadcast programs by a VOD (video on demand) in addition to a live broadcast and re-broadcast distribution of the programs. The terminal devices 20 to 40 display videos and sounds of the distributed program aside from the videos and sounds of the live broadcasted or the re-broadcasted programs.

Hereinafter, the user of the terminal device 40 is assumed to have performed an operation on the terminal device 40 to transmit a request (hereinafter referred to as the “VOD distribution request”) to have the live broadcasted program to be distributed by the VOD.

The terminal device 40 transmits the VOD distribution request to the sound recognition device 100 according to this operation. When the VOD distribution request is received on the terminal device 40, the sound recognition device 100 then reads out multimedia data that represents the program relevant to the distribution request, and establishes the distribution of the read-out multimedia data to the terminal device 40. The terminal device 40 saves the multimedia data received from the sound recognition device 100 and starts to display the program image represented by the multimedia data and to output the program sound.

Then, hereinafter, the user of the terminal device 40 is assumed to have made a skip operation on the terminal device 40 to move forward a play location of the distributed program over to a predetermined time later.

The terminal device 40 discontinues displaying the program image and discontinues outputting the sound from the program, then transmits a skip command to the sound recognition device 100. The skip command provides an instruction to skip in addition to a period of time to skip. When the skip command is received, the sound recognition device 100 resumes to read out and to distribute the multimedia data after shifting the read-out position in backwards by a size that is equivalent to a time period specified by the skip command. Then, the terminal device 40 again saves the distributed multimedia data, and displays the program image represented by the multimedia data, and outputs the program sound.

Then, if another skip operation is performed on the terminal device 40 to rewind the play location of the distributed program to go back by a predetermined time period, then the terminal device 40 discontinues to display the program image and discontinues to output the program sound, then resumes to play the program image and output the program sound from the play location that is forwarded by a size equivalent to a time period specified by the skip operation, by using the multimedia data that is previously saved.

Further, when the user of the terminal device 40 performs a pause operation on the terminal device 40 to temporarily stop playing the distributed program, then the terminal device 40 discontinues to display the program image and discontinues to output the program sound. After that, when the user of the terminal device 40 performs an operation of a frame-by-frame playback of the distributed program on the terminal device 40, then the program sound output is discontinued, and the frame-by-frame playback of the program image is resumed by using the distributed or previously saved multimedia data.

Further, when the user of the terminal device 40 performs a stop operation on the terminal device 40 to stop playing the program, then the terminal device 40 discontinues displaying the program image and discontinues outputting the program sound, then transmits a stop command to the sound recognition device 100 to give an instruction to stop. When the stop command is received on the terminal device 40, the sound recognition device 100 then stops distribution of the multimedia data according to the stop command.

Here, note that Embodiments 1 to 4 may be combined. The functionalities of any one of Embodiments 1 to 4 may certainly be provided simply by making an application of the sound recognition device 100 that includes the features required for realizing such functionalities. Yet, the same functionalities may also be provided by a system constituted by multiple devices, which as a whole includes the functionalities of any one of Embodiments 1 to 4.

Note that the sound recognition device 100 including configurations for realizing the functions of Embodiment 1, the sound recognition device 200 including configurations for realizing the functions of Embodiment 2, or a sound recognition device including configurations for realizing functions of Embodiment 3 or Embodiment 4, may certainly be provided by pre-arranging the configurations on the respective sound recognition device. Furthermore, the existing sound recognition device may also be able to achieve functions of the sound recognition device 100 of Embodiment 1, that of the sound recognition device 200 of Embodiment 2, or that of the sound recognition device of Embodiment 3 or Embodiment 4, by implementing computer programs. In other words, the sound recognition device 100 of Embodiment 1, the sound recognition device 200 of Embodiment 2, or the sound recognition device of Embodiment 3 or 4, may be achieved by making the existing computer (such as CPU) used to control the sound recognition device executable of the sound recognition program that allows to realize each function included in the sound recognition device 100 exemplified in Embodiment 1, the sound recognition device 200 exemplified in Embodiment 2, or the sound recognition device exemplified in Embodiment 3 or 4.

The method for program distribution as discussed is determined by discretion such that, the programs may be distributed as stored in a storage medium such as a memory card, a CD-ROM, or a DVD-ROM, or may be distributed through a communication medium such as internet. In addition, the sound recognition method according to the present invention can be carried out using the sound recognition device 100 of Embodiment 1, the sound recognition device 200 of Embodiment 2, or the sound recognition device of Embodiment 3 or Embodiment 4.

Although preferred embodiments of the present invention have been described in detail, it should be understood that numerous other modifications and embodiments can be devised by those skilled in the art that will fall within the spirit and the scope of the principle of this invention.

What is claimed is:

1. A sound recognition device comprising:
a storage for storing a comment that is input by a user while listening to a sound emitted via playing multimedia data;
an extractor for extracting candidate words including a word occurred in a set of sentences that contain the stored comment, and a co-occurrence of the word contained in the set of sentences; and
a sound recognizer for recognizing the sound emitted via playing the multimedia data, recognizing based on the extracted candidate words.

2. The sound recognition device according to claim 1, wherein
the set of sentences comprising a sentence that occurred in a document viewed by the user of the multimedia data.

3. The sound recognition device according to claim 1, wherein
the extractor determines a likelihood of occurrence for the each candidate word, and
the sound recognizer recognizes the sound based on a degree of coincidence between a phoneme that is recognized in the sound and a phoneme that describes the candidate words, and on the likelihood of occurrence of the candidate words.

4. The sound recognition device according to claim 3, wherein
a word among the candidate words, that occurred in the comment, is associated with an input time point at which an input of the comment is made,
as for the candidate words associated with the input time point, the sound recognizer requests to obtain a degree of coincidence between an input time point associated with the candidate words, and a sound emission time point at which the phoneme is emitted, and the sound recognizer further performs a sound recognition based on the obtained degree of coincidence.

5. The sound recognition device according to claim 4, wherein
the input time point and the sound emission time point are depending on a period of play time starting from a multimedia data play start.

6. The sound recognition device according to claim 5, wherein
the degree of coincidence is defined based on a difference between the input time point and the sound emission time point, and a difference between a time point at which the multimedia data is ready to play and a time point at which the user started to play the multimedia data.

7. A non-transitory computer readable storage medium having stored thereof a sound recognition program executable by a computer, causing the computer to realize functions of:
storing a comment that is input by a user while listening to a sound emitted via playing multimedia data;
extracting candidate words including a word occurred in a set of sentences that contain the stored comment, and a co-occurrence of the word contained in the set of sentences; and
recognizing the sound emitted via playing the multimedia data, and recognizing based on the extracted candidate words.

8. A sound recognition method performed by a sound recognition device comprising a storage, an extractor, and a sound recognizer, comprising the steps of:
storing a comment that is input by a user while listening to a sound emitted via playing multimedia data;
extracting candidate words including a word occurred in a set of sentences that contain the stored comment, and a co-occurrence of the word contained in the set of sentences; and
recognizing the sound emitted via playing the multimedia data, and recognizing based on the extracted candidate words.
